(19) United States
(12) Patent Application Publication
(10) Pub. No.: US 2025/0365745 A1
(43) Pub. Date: Nov. 27, 2025

(54) METHOD FOR RESOURCE MAPPING, AND TERMINAL DEVICE AND CHIP THEREOF

(71) Applicant: GUANGDONG OPPO MOBILE TELECOMMUNICATIONS CORP., LTD., Dongguan (CN)

(72) Inventor: Shichang ZHANG, Dongguan (CN)

(21) Appl. No.: 19/292,284

(22) Filed: Aug. 6, 2025

Related U.S. Application Data
(63) Continuation of application No. PCT/CN2023/093661, filed on May 11, 2023.

(51) Int. Cl. H04W 72/25; H04B 17/318; H04L 5/00; H04W 72/044

(52) U.S. Cl. CPC H04W 72/25; H04B 17/328; H04L 5/0051; H04W 72/044

(57) ABSTRACT

Provided is a method for resource mapping. The method is performed by a terminal device, and includes: mapping modulation symbols of second-stage sidelink control information (SCI) to a time-frequency resource, wherein the second-stage SCI at least indicates transmission of a sidelink (SL) positioning reference signal (PRS). The the modulation symbols of the second-stage SCI are mapped starting from a first orthogonal frequency-division multiplexing (OFDM) symbol containing a physical sidelink shared channel (PSSCH) demodulation reference signal (DMRS).

### CROSS-REFERENCE TO RELATED APPLICATION

This application is a continuation of International Application No. PCT/CN2023/093661, filed May 11, 2023, the entire disclosure of which is incorporated herein by reference.

### TECHNICAL FIELD

The present disclosure relates to the technical field of communications, and in particular, relates to a method for resource mapping, and a terminal device and a chip thereof.

### RELATED ART

With developments of sidelink communication, sidelink-based positioning has been introduced. In the sidelink-based positioning, a sidelink positioning reference signal (SL PRS) needs to be transmitted between terminal devices in the sidelink communication, and transmission of the SL PRS may be indicated via second-stage sidelink control information (SCI).

### SUMMARY

Embodiments of the present disclosure provide a method for resource mapping, and a terminal device and a chip thereof. The technical solutions are as follows.

According to some embodiments of the present disclosure, a method for resource mapping is provided. The method is performed by a terminal device, and includes:
mapping modulation symbols of second-stage SCI to a time-frequency resource, wherein the second-stage SCI at least indicates transmission of an SL PRS.

According to some embodiments of the present disclosure, a terminal device is provided. The terminal device includes: a processor and a memory storing one or more computer programs; wherein the processor is configured to load and run the one or more computer programs to cause the terminal device to perform the method for resource mapping.

According to some embodiments of the present disclosure, a chip is provided. The chip includes programable logical circuitry and/or program instructions, wherein the chip, when running, is configured to perform the method for resource mapping.

### BRIEF DESCRIPTION OF DRAWINGS

FIG. 1 is a schematic diagram of a network architecture according to some embodiments of the present disclosure;

FIG. 2 is a schematic diagram of part of symbols in a slot for SL transmission according to some embodiments of the present disclosure;

FIG. 3 is a schematic diagram of a slot structure of a physical sidelink control channel (PSCCH) and a physical sidelink shared channel (PSSCH) according to some embodiments of the present disclosure;

FIG. 4 is a schematic diagram of time-domain positions of four demodulation reference signals (DMRSs) in a case where a PSSCH includes 13 symbols according to some embodiments of the present disclosure;

FIG. 5 is a schematic diagram of a frequency-domain position of a PSSCH DMRS according to some embodiments of the present disclosure;

FIG. 6 is a schematic diagram of a PSCCH and PSSCH resource pool in new radio (NR)-vehicle-to-everything (V2X) according to some embodiments of the present disclosure;

FIG. 7 is a schematic diagram of a slot structure in an NR system according to some embodiments of the present disclosure;

FIG. 8 is a schematic diagram of a comb size and resource element (RE) offsets according to some embodiments of the present disclosure;

FIG. 9 is a schematic diagram of interlaced resource blocks (IRBs) according to some embodiments of the present disclosure;

FIG. 10 is a schematic diagram of an IRB-based frame structure according to some embodiments of the present disclosure;

FIG. 11 is a schematic diagram of resource block sets according to some embodiments of the present disclosure;

FIG. 12 is a flowchart of a method for resource mapping according to some embodiments of the present disclosure;

FIG. 13 is a schematic diagram of a slot structure of a PSCCH and a PSSCH according to some embodiments of the present disclosure;

FIG. 14 is a schematic diagram of mapping of second-stage SCI according to some embodiments of the present disclosure;

FIG. 15 a schematic diagram of mapping of second-stage SCI and a SL PRS according to some embodiments of the present disclosure;

FIG. 16 a schematic diagram of mapping of second-stage SCI and a SL PRS according to some embodiments of the present disclosure;

FIG. 17 a schematic diagram of mapping of second-stage SCI and SL PRSs according to some embodiments of the present disclosure;

FIG. 18 a schematic diagram of mapping of second-stage SCI and SL PRSs according to some embodiments of the present disclosure;

FIG. 19 is a block diagram of an apparatus for resource mapping according to some embodiments of the present disclosure; and

FIG. 20 is a schematic structural diagram of a terminal device according to some embodiments of the present disclosure.

### DETAILED DESCRIPTION

For clearer descriptions of the objects, technical solutions, and advantages of the present disclosure, the embodiments of the present disclosure are described in detail hereinafter in combination with the accompanying drawings.

The network architecture and service scenarios described in the embodiments of the present disclosure are intended to illustrate the technical solutions according to the embodiments of the present disclosure more clearly instead of any limitations. Those skilled in the art understand that with evolution of the network architecture and emergence of new service scenarios, the technical solutions according to the embodiments of the present disclosure are also applicable to addressing similar technical problems.

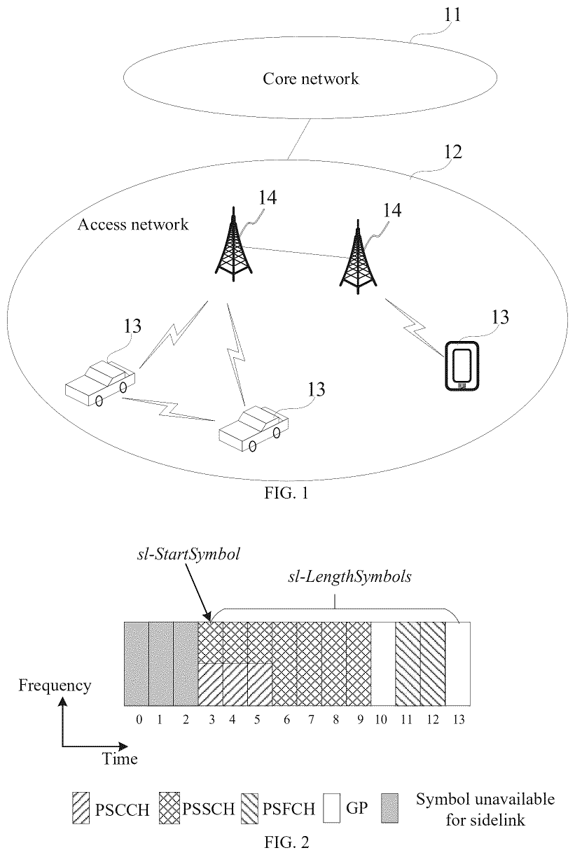

FIG. 1 is a block diagram of a network architecture according to some embodiments of the present disclosure. The network architecture involves a core network 11, an access network 12, and a terminal device 13.

The core network 11 includes several core network devices. Each of the core network devices mainly functions to provide user connection, user management, and service bearing, and is determined as a bearer network for providing an interface to an external network. For example, a core network of a 5th generation (5G) NR system includes an access and mobility management function (AMF) entity, a user plane function (UPF) entity, a session management function (SMF) entity, and other devices.

The access network 12 includes several access network devices 14. The access network in the 5G NR system is also referred to as a new generation-radio access network (NG-RAN). Each of the access network devices 14 is a device deployed in the access network 12 and configured to provide a wireless communication function for the terminal device 13. The access network devices 14 include various types of macro base stations, micro base stations, relay stations, access points, and the like. In systems using different radio access technologies, the devices with the functionality of the access network device have different names, for example, gNodeBs or gNBs in 5G NR systems. With the evolution of communications technologies, the name “access network device” varies. For convenient description, the devices providing the wireless communication function for the terminal device 13 are collectively referred to as the access network device in the embodiments of the present disclosure.

Generally, a plurality of terminals are provided. One or more terminal devices 13 may be deployed in a cell managed by each of the access network devices 14. The terminal devices 13 includes various handheld devices, vehicle-mounted devices, wearable devices, computing devices or other processing devices connected to wireless modems, various forms of user equipments (UEs), mobile stations (MSs), and other devices with the wireless communication function. For convenient description, the devices are collectively referred to as the terminal device. The access network device 14 and the core network device communicate with each other using the air interface technology, such as an NG interface in a GG NR system. The access network device 14 and the terminal device 13 communicate with each other using the air interface technology, such as a Uu interface. The terminal device in the embodiments of the present disclosure is also referred to as the UE, which have the same meaning.

The terminal device 13 and the terminal device 13 (for example, the vehicle-mounted device and other devices (e.g., other vehicle-mounted devices, mobile phones, road side units (RSU), or the like) communicate with each other via a direct communication interface (for example, a ProSe Communication 5 (PC5) interface), and the communication link established via the direct communication interface is accordingly referred to as a direct link or an SL. SL communication indicates that communication data transmission between the terminal devices is achieved via the SL, which is different from the traditional cellular system in which the communication data is received or transmitted via the access network device. Thus, the SL communication has the characteristics of short delay and low overhead, and is suitable for communication between two terminal devices at near geographical locations (e.g., a vehicle-mounted device and other peripheral devices at near geographical locations). It should be noted that FIG. 1 is only illustrated using the vehicle-to-vehicle communication in the V2X scenario as an example, and the SL technology is applicable to a scenario where various terminal devices directly communicate with each other. In other words, the terminal device in the present disclosure is any device implementing the communication using the SL technology.

The “5G NR system” in the embodiments of the present disclosure is also referred to as a 5G system or an NR system, and those skilled in the art can understand the meaning. The technical solutions according to the embodiments of the present disclosure are applicable to the 5G NR system and evolved systems of the 5G NR system.

Before description of the technical solutions according to the present disclosure, some background technical knowledge involved in the present disclosure are introduced and explained first. The following related technologies, as optional solutions, may be combined arbitrarily with the technical solutions according to the embodiments of the present disclosure, which fall within the scope of protection of the embodiments of the present disclosure. The embodiments of the present disclosure include at least part of the following content.

### 1. Slot Structure in NR-V2X

In NR-V2X, the PSSCH and the associated PSCCH are transmitted in the same slot, and the PSCCH occupies two or three slot symbols. Time-domain resource allocation in NR-V2X is performed at a slot granularity. A starting point and a length of time-domain symbols used for sidelink transmission in a slot are configured based on parameters sl-startSLsymbols and sl-lengthSLsymbols. A last symbol in the symbols is used as a guard period (GP), and thus the PSSCH and the PSCCH only use other time-domain symbols than the last symbol. However, in a case where the a physical sidelink feedback channel (PSFCH) transmission resource is configured in a slot, the PSSCH and the PSCCH are not allowed to occupy a time-domain symbol used for PSFCH transmission and an automatic gain control (AGC) and a GP symbol before the symbol.

As illustrated in FIG. 2, the network configures sl-StartSymbol=3 and sl-LengthSymbols=11. That is, 11 time-domain symbols from symbol 3 (the symbol with index 3) in a slot are used for sidelink transmission. The slot includes the PSFCH transmission resource, and the PSFCH occupies symbol 11 and symbol 12. Symbol 11 is used as an AGC symbol of the PSFCH, symbols 10 and 13 are used as GPs, and time-domain symbols used for PSSCH transmission are symbol 3 to symbol 9. The PSCCH occupies three time-domain symbols, that is, symbol 3, symbol 4, and symbol 5, and symbol 3 are generally used as AGC symbols.

In the NR-V2X, a sidelink slot includes a PSFCH other than the PSCCH and the PSSCH. In the slot, a first orthogonal frequency-division multiplexing (OFDM) symbol is generally used as an AGC, and the UE replicates information transmitted on a second symbol on the AGC symbol. A last symbol in the slot is used for transmission and reception conversion, that is, used for the UE to convert from a transmission (or reception) state to a reception (or transmission) state. In the remaining OFDM symbols, the PSCCH occupies two or three OFDM symbols from a second sidelink symbol. In the frequency domain, the number of physical resource blocks (PRBs) occupied by the PSCCH is within a sub-band range of the PSSCH. In a case where the number of PRBs occupied by the PSCCH is less than a size of a sub-channel of the PSSCH, or in a case where the frequency-domain resource of the PSSCH includes a plurality of sub-channels, frequency-division multiplexing is performed on the PSCCH and the PSSCH on the OFDM symbol containing the PSCCH.

The PSSCH is used to carry second-stage SCI and a SL-shared channel (SCH). Two second-stage SCI formats, that is, SCI format 2-A and SCI format 2-B, are defined in the related technologies. SCI format 2-B is applicable to a multicast communication mode for sidelink hybrid automatic repeat request (HARQ) feedback based on distance information; and SCI format 2-A is applicable to other scenarios, for example, unicast, multicast, and broadcast that do not need sidelink HARQ feedback, a unicast communication mode that needs the sidelink HARQ feedback, and a multicast communication mode that needs to feed back an acknowledgment (ACK) or a negative acknowledgment (NACK). A second-stage SCI format, that is, SCI format 2-C, is additionally introduced in the related technologies, and SCI format 2-C is used to indicate a reference resource set and a trigger signaling in some cases. The modulation symbols of the second-stage SCI are mapped in a sequence of first frequency domain and then time domain from a symbol containing a first PSSCH DMRS, and are multiplexed with REs of the DMRS in an interlaced mode on the symbol. Moreover, the modulation symbols of the second-stage SCI are mapped to an RE of a phase track reference signal (PT-RS), as illustrated in FIG. 3.

TABLE 1
Orthogonal cover codes (OCCs) of PSCCH DMRS

OCC

| OCC index | i = 0 | i = 1 | i = 2 |
|---|---|---|---|
| 0 | 1 | 1 | 1 |
| 1 | 1 | e^{j2/3π} | e^{-j2/3π} |
| 2 | 1 | e^{-j2/3π} | e^{j2/3π} |

In a sidelink communication system, different UEs transmit the PSCCH on the same time-frequency resource as the UE autonomously selects the resource or determines a transmission resource based on sidelink resource scheduling of the network. The PSCCH DMRS is random in LTE-V2X to ensure that the receiver detect at least one PSCCH in PSCCH resource collision. Specifically, in a case where the UE transmits the PSCCH, the UE randomly selects a value from a set {0, 3, 6, 9} as a cyclic shift value of the DMRSs. In a case where PSCCH DMRSs transmitted by a plurality of UEs on the same time-frequency resource adopt different cyclic shift values, the receiver UE still detects at least one PSCCH via an orthogonal DMRS. For the same purpose, three PSCCH DMRS frequency-domain OCCs are configured in NR-V2X for random selection by the transmitter UE, as listed in Table 1. An i^{th} bit of the OCC is applicable to an i^{th} DMRS RE in the resource block (RB) to distinguish different UEs.

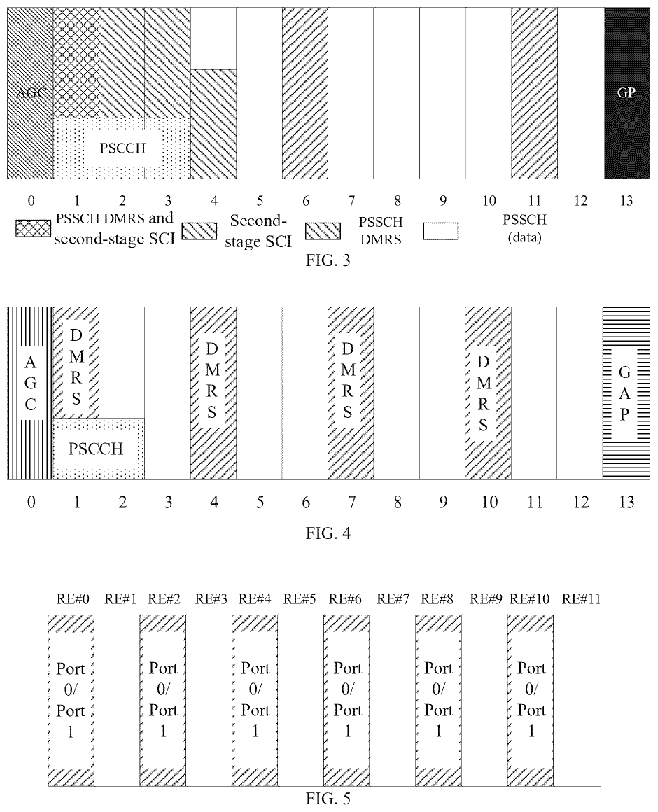

The DMRS of the PSSCH in NR-V2X draws on the design of the Uu interface in the NR, and a plurality of time-domain PSSCH DMRS patterns are used. In a resource pool, the number of available DMRS patterns is related to the number of PSSCH symbols in the resource pool. For a specific number of PSSCH symbols (including the first AGC symbol) and a specific number of PSCCH symbols, the available DMRS patterns and positions of DMRS symbols in the pattern are illustrated in Table 2. FIG. 4 is schematic diagram of time-domain positions of four DMRSs in a case where a PSSCH includes 13 symbols.

TABLE 2
Number of DMRS symbols and positions of DMRS symbols in different numbers of PSSCH symbols
and numbers of PSCCH symbols

| Number of | Positions of DMRS symbol (relative to a position of a first AGC symbol) | | | | | |
|---|---|---|---|---|---|---|
| PSSCH | Number of PSCCH | | | Number of PSCCH | | |
| symbols | symbols being 2 | | | symbols being 3 | | |
| (including a | Number of DMRS | | | Number of DMRS | | |
| first AGC | symbols | | | symbols | | |
| symbol) | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

In a case where a plurality of time-domain DMRS patterns are configured in the resource pool, the transmitter UE selects a specific used time-domain DMRS pattern and indicates the time-domain DMRS pattern in first-stage SCI. In this way, a high-speed moving UE selects a high-density DMRS pattern to ensure an accuracy of channel estimation, and a the low-speed moving UE uses a low-density DMRS pattern to improve spectral efficiency.

The method for generating the PSSCH DMRS sequence is almost the same as the method for generating the PSCCH DMRS sequence, and the two methods only differ in that a initialization parameter of a pseudo-random sequence c(m) is cᵢₙᵢₜ,

$${N}_{D} = {\sum }_{i = 0}^{L - 1} {p}_{i} \cdot {2}^{L - 1 - i}$$

is used to determine cᵢₙᵢₜ, pᵢ is i^{th} cyclic redundancy check (CRC) of the PSCCH for scheduling the PSSCH, and L=24 L is the number of bits of the PSCCH CRC.

Two frequency-domain DMRS patterns, that is DMRS frequency-domain type 1 and DMRS frequency-domain type 2, are supported in the NR PDSCH and the physical uplink shared channel (PUSCH). For each frequency-domain type, two different types (that is, a single DMRS symbol and a double DMRS symbol) are configured. The single-symbol DMRS frequency-domain type 1 supports four DMRS ports, and the single-symbol DMRS frequency-domain type 2 supports six DMRS ports. For the double DMRS symbols, a number of supported ports doubles. However, in NR-V2X, as the PSSCH only needs to support at most two DMRS ports, only the single-symbol DMRS frequency-domain type 1 is supported, as illustrated in FIG. 5.

### 2 Determination of Frequency-Domain Resources in NR-V2X

Similar to LTE-V2X, frequency-domain resources of the NR-V2X resource pool are also contiguous, and an allocation granularity of the frequency-domain resources is also a sub-channel. A number of PRBs in a sub-channel is any one of {10, 12, 15, 20, 50, 75, 100}. A minimum size of the sub-channel is 10 PRBs, which is much greater than a minimum size 4 PRBs of the sub-channel in LTE-V2X. The reason for the case is that in NR-V2X, the frequency-domain resources of the PSCCH are configured in a first sub-channel of the associated PSSCH, the frequency-domain resources of the PSCCH are less than or equal to the size of the sub-channel of the PSSCH, time-domain resources of the PSCCH occupy two or three OFDM symbols, and few available resources for the PSCCH, an increased bit rate, and a reduced detection performance of the PSCCH are caused in a case where the size of the sub-channel is small. In NR-V2X, the size of the sub-channel of the PSSCH and the size of the frequency-domain resources of the PSCCH are independently configured on the premise that the frequency-domain resources of the PSCCH are less than or equal to the size of the sub-channel of the PSSCH. The following configuration parameters in the NR-V2X resource pool configuration information are used to determine the frequency-domain resources of a PSCCH and PSSCH resource pool.
sl-SubchannelSize, indicating a number of contiguous PRBs in a sub-channel in a resource pool, with a value range of {10, 12, 15, 20, 50, 75, 100}PRBs;
sl-NumSubchannel, indicating a number of sub-channels in a resource pool;
sl-StartRB-Subchannel, indicating an index of a start RB in a first sub-channel in a resource pool;
sl-RB-Number, indicating a number of contiguous PRBs in a resource pool; and
sl-FreqResourcePSCCH, indicating a size of frequency-domain resources in a PSCCH, with a value range of {10, 12, 15, 20, 25}PRBs.

In a case where the UE determines a resource pool for PSSCH transmission or PSSCH reception, frequency-domain resources in the resource pool are sl-NumSubchannel contiguous sub-channels from a PRB indicated by sl-StartRB-Subchannel. In a case where the number of PRBs in sl-NumSubchannel contiguous sub-channels is less than the number of PRBs indicated by sl-RB-Number, remaining PRBs are not used for PSSCH transmission or PSSCH reception.

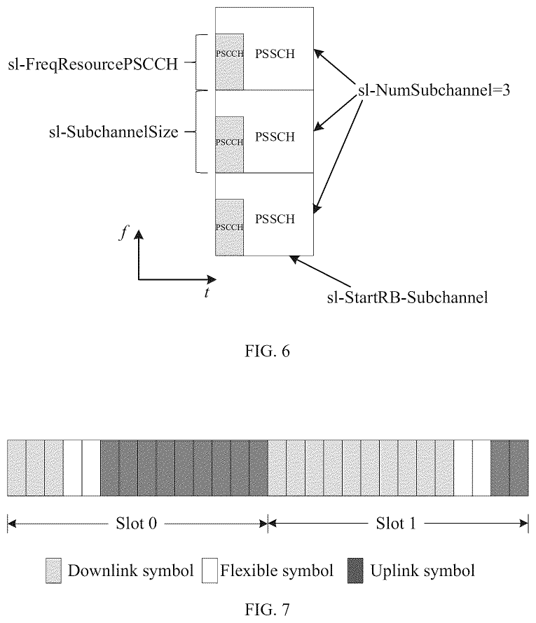

In the NR-V2X, a frequency-domain starting position of the first sub-channel of the PSCCH and a frequency-domain starting position of the first sub-channel of the associated PSSCH are aligned. Therefore, the starting position of the sub-channel of each PSSCH may be the frequency-domain starting position of the PSCCH, and the frequency domain range of the PSCCH and PSSCH resource pool is determined based on above parameters, as illustrated in FIG. 6. In NR-V2X, the PSCCH is used to carry and monitor related SCI, and the SCI includes:
a priority of scheduled transmission;
frequency-domain resource allocation, indicating a number of frequency-domain resources of the PSSCH scheduled by the PSCCH in the current slot, and the number of frequency-domain resources and the starting position of the frequency-domain resources of at most two reserved retransmission resources;
time-domain resource allocation, indicating the time-domain location of at most two reserved retransmission resources;
a reference signal pattern of the PSSCH;
second-stage SCI format;
second-stage SCI bitrate offset;
the number of PSSCH DMRS ports;
modulation and coding scheme (MCS)
MCS form indication;
a number of symbols of the PSFCH;
a resource reservation periodicity, reserving resources for transmission of another transport block (TB) in the next periodicity. in a case where intra-TB resource reservation is not activated in the resource pool configuration, the information bit field is not present.
reserved bits, 2 to 4 bits. The exact number of bits is configured by network or pre-configured.

As the PSCCH and the scheduled PSSCH are always transmitted in the same slot, and the starting position of the PRBs occupied by the PSCCH is the starting position of the first sub-channel of the scheduled PSSCH, the time-domain starting position of the and the frequency-domain starting position of the scheduled PSSCH are not explicitly indicated in SCI format 1-A.

### 3 Determination of Time-Domain Resources (Slots) in NR-V2X

In NR-V2X, transmission of the PSCCH/PSSCH is at a slot level. That is, only one PSCCH/PSSCH is transmitted in a slot, a plurality of PSCCHs/PSSCHs are not transmitted in a slot through a time division multiplexing (TDM) mode, and PSCCHs/PSSCHs between different users are multiplexed in a slot through a frequency-division multiplexing (FDM) mode. The time-domain resources of the PSSCH in NR-V2X are at a slot granularity. However, unlike in LTE-V2X where the PSSCH occupies all the time-domain symbols in a sub-frame, the PSSCH in NR-V2X may occupy some symbols in a slot. The case is mainly because in the LTE system, uplink transmission and downlink transmission are also at a sub-frame granularity. Therefore, sidelink transmission is also at the sub-frame granularity (special subframes in the TDD system are not used for sidelink transmission). In the NR system, a flexible slot structure is adopted, that is, both the uplink symbol and the downlink symbol are in a slot. Thus, more flexible scheduling is achieved, and the latency is reduced. A typical subframe of an NR system are illustrated in FIG. 7. The slot includes downlink (DL) symbols, uplink (UL) symbols, and flexible symbols. The downlink symbols are located at the beginning of the slot, the uplink symbols are located at the end of the slot, flexible symbols are located between the downlink symbols and uplink symbols, and numbers of various symbols in each slot are configurable.

The sidelink transmission system shares the carrier with the cellular system. In this case, the uplink transmission resources of the cellular system are used in the sidelink transmission. For NR-V2X, in a case where sidelink transmission needs to occupy all the time-domain symbols in a slot, the network needs to configure a slot with all uplink symbols for the sidelink transmission, such that the uplink and downlink data transmission of the NR system is greatly affected, and the performance of the system is reduced. Therefore, in NR-V2X, some time-domain symbols in a slot are used for the sidelink transmission, that is, some uplink symbols in a slot are used for the sidelink transmission. In addition, as the AGC symbols and the GP symbols are included in the sidelink transmission, and fewer symbols available for valid data transmission and a low resource utilization rate are caused by removing the AGC symbols and the GP symbols in a case where the number of uplink symbols available for sidelink transmission is small. Therefore, in NR-V2X, the sideline transmission occupies at least seven time-domain symbols (including the GP symbol). In a case where the sidelink transmission system uses a proprietary carrier, the sidelink transmission system does not share transmission resources with other systems, and all symbols in the slot are configured for sidelink transmission.

As mentioned above, in NR-V2X, the starting point and the length of time-domain symbols for sidelink transmission in a slot are configured based on a position of a starting symbol sl-StartSymbol and a number of symbols sl-LengthSymbols. The last symbol in the time-domain symbol for sidelink transmission is used as the GP. The PSSCH and the PSCCH only use remaining time-domain symbols. However, in a case where the PSFCH transmission resources are configured in a slot, the PSSCH and the PSCCH cannot occupy the time-domain symbols for PSFCH transmission, the AGC symbol, and the GP symbols prior to the time-domain symbols.

In the NNR-V2X system, the time-domain resources of the resource pool are also indicated by a bitmap. Due to the flexible slot structure in the NR system, the length of the bitmap is expanded, and the supported length range of the bit bitmap is [10:160]. The method for determining the position of the slot belonging to the resource pool in a system frame number (SFN) periodicity using the bitmap in NNR-V2X and the method in LTE-V2X are the same and differ in that:
a total number of slots in an SFN periodicity is 10240×2^{μ}, wherein the parameter u is related to a size of a sub-carrier interval.
in a case where at least one of time-domain symbols Y, Y+1, Y+2, . . . , Y+X−1 in a slot is not configured as an uplink symbol by a TDD-UL-DL-ConfigCommon signaling of the network, the slot cannot be used for sidelink transmission, wherein Y and X represent sl-StartSymbol and sl-LengthSymbols respectively.

Specifically,
In S1, slots that do not belong to the resource pool in the SFN periodicity are removed. The slots include synchronous slots and slots that cannot be used for sidelink transmission, and remaining slots are represented as a remaining slot set and are renumbered as (l₀, l₁, . . . , l_{(10240×2}_{^{μ}}_{-N}_{_{S_SSB}}_{-N}_{_{nonSL}}₋₁₎);
   wherein N_{S_SSB} represents a number of synchronous slots in an SFN periodicity, and the synchronization slot is determined based on a synchronization-related configuration parameter and is related to a periodicity for transmitting a synchronization signal block (SSB), a number of transmission resources of the SSB configured in the periodicity, and the like;
   N_{nonSL} represents a number of slots in an SFN periodicity that do not conform to the starting point of the uplink symbol and number configuration. In a case where at least one of time-domain symbols Y, Y+1, Y+2, . . . , Y+X−1 in a slot is not semi-persistently configured as an uplink symbol, the slot cannot be used for sidelink transmission, wherein Y and X represent sl-StartSymbol and sl-LengthSymbols respectively.
In S2, a number of reserved slots and corresponding time-domain positions are determined;
   in a case where a number of slots in the remaining slot set is divided evenly by a length of the bitmap, the number of reserved slots and the corresponding time-domain positions are determined. Specifically, in a case where a slot lᵣ (0≤r<10240×2^{μ}−N_{S_SSB}−N_{nonSL}) satisfies the following conditions, the slot is a reserved slot.

$$r = ⌊ \frac{m \cdot ( 10240 \times {2}^{μ} - {N}_{S \_ SSB} - {N}_{nonSL} )}{{N}_{reserved}} ⌋ ;$$

N_{reserved}=(10240×2^{μ}−−N_{S_SSB}−N_{nonSL})mod L_{bitmap}, and N_{reserved} represents the number of reserved slots, and L_{bitmap} represents the length of the bitmap, m=0, . . . , N_{reserved}−1.
In S3, the reserved slots are removed from the remaining slot set. The remaining slot set is represented as a logical slot set. All slots in the slot set are available for the resource pool, and are renumbered as

$$( {t}_{0}^{SL} , {t}_{1}^{SL} , … , {t}_{{T}_{max} - 1}^{SL} ) .$$

$${T}_{max} = 10240 \times {2}^{μ} - {N}_{S \_ SSB} - {N}_{nonSL} - {N}_{reserved} .$$

In S4, the slots belonging to the resource pool in the logical slot set are determined based on the bitmap.
   the bitmap in the resource pool configuration information is (b₀, b₁, . . . , b_{L}_{_{bitmap}}₋₁). For the slot

$${t}_{k}^{SL} ( 0 \leq k < ( 10240 \times {2}^{μ} - {N}_{S \_ SSB} - {N}_{nonSL} - {N}_{reserved} ) )$$

in the logical slot set, in a case where b_{k′}=1, the slot belongs to the resource pool. k′=k mod L_{bitmap}.
In S5, the slots determined in S4 that belong to the resource pool are renumbered as

$${t}_{i}^{′ SL} ,$$

wherein i∈{0, 1, . . . , T′ₘₐₓ−1}, and T′ₘₐₓ represents the number of slots in the resource pool.

### 4 Positioning Based on the Downlink Link

In the positioning based on the downlink link, DL PRS configuration of at most four positioning frequency layers are provided for a UE. A parameter structure of each positioning frequency layer is provided with following configuration parameters of the PRS:
A sub-carrier interval of the PRS signal.
A length of a cyclic prefix (CP) of the PRS signal.
A bandwidth of frequency-domain resources of the PRS, a value of the parameter is the number of PRBs allocated to the PRS signal. A minimum bandwidth of the resources of the PRS is 24 PRBs with a granularity of 4 PRBs, and a maximum bandwidth is 272 PRBs.
A starting frequency position of the frequency domain of the resources of the PRS, defining an index number of a starting PRB allocated to the PRS signal in the frequency domain. The index number of PRB is defined relative to Point A of the PRS.
A frequency-domain reference point (Point A) of the PRS signal.
A comb size of the PRS signal is comb-N.

The PRS parameters configured in each positioning frequency layer are applicable to all PRS resources in the positioning frequency layer. That is, in a positioning frequency layer, all PRS signals from a plurality of different transmission and reception points (TRPs) adopt the same sub-carrier interval, the same length of the CP, and the same comb size, are transmitted on the same frequency sub-band, and occupy exactly the same bandwidth. In this way, the UE simultaneously receives and measures PRS signals from a plurality of different TRPs at the same frequency point.

The parameters of the TRP layer include an identifier (ID) parameter for uniquely identifying the positioning TRP, a physical cell ID of the TRP, and an NR cell global ID (NCGI) of the TRP, and an absolute radio frequency channel number (ARFCN) of the TRP. At most two DL PRS resource sets are configured in each TRP layer. The parameters of the layer of the DL PRS resource set are configured with the following parameters applicable to all the DL PRS resources in the resource set.
An ID of a DL PRS resource set (nr-DL-PRS-ResourceSetID).
A transmission periodicity and slot offset of the DL PRS (dl-PRS-Periodicity-and-ResourceSetSlotOffset), defining time-domain transmission behaviors of all DL PRS resources in the DL PRS resource set. A minimum configurable transmission periodicity of the DL PRS is 4 milliseconds, and a maximum transmission periodicity is 10240 milliseconds. The configuration of the DL PRS supports flexible sub-carrier intervals, including 15 KHz, 30 KHz, 60 KHz, and 120 KHz. In different sub-carrier intervals, ranges of configurable DL PRS transmission periodicity are the same. FIG. 8 is a schematic diagram with a comb size of 2 and RE offsets of 0 and 1.
A repetition factor of the DL PRS resources (dl-PRS-ResourceRepetitionFactor), defining a number of repetitive transmissions of a PRS resource in each PRS periodicity. The repetitive transmission of the same DL PRS resource is used by the UE to collect the energy of DL PRS signals that are transmitted several times to increase a coverage distance of the DL PRS and a positioning accuracy. In the FR2 system, the repetitive transmission of the DL PRS resources is used by the UE as a receive beam sweeping operation. The UE uses different receive beams to receive the repetitive transmission of the same DL PRS resource to find an optimal TRP transmit beam to match the UE receive beam. In addition, the repetitive transmission of the DL PRS resource increases an overhead of the PRS. In the specification of 3GPP NR R16, a repetition value of the DL PRS resources is any one of 1, 2, 4, 6, 8, 16, and 32.
A time interval for repetitive transmission of the DL PRS resource (dl-PRS-ResourceTimeGap), defining a number of slots between two contiguous repetitive transmissions of the same PRS resource.
Muting configuration of the DL PRS, defining that a DL PRS signal is not transmitted on an allocated time-frequency resource (referred to as muting). Muting refers to the fact that the DL PRS signal is not transmitted on all allocated time-frequency resources, and is intentionally not transmitted on a specified time-frequency resource. The muting is designed to avoid collision with other signals (for example, the SSB) and avoid interference between signals from different TRPs. For example, transmission of the DL PRS a TRP is intentionally suspended at a moment, such that the UE receives a DL PRS signal from a remote TRP. The muting operation of the PRS is described in detail in the subsequent description, which is not elaborated herein.
A number of OFDM symbols occupied by the DL PRS resource (dl-PRS-NumSymbols), defining a number of OFDM symbols allocated to a DL PRS resource in a slot.

As mentioned above, all parameters configured in the configuration layer of a DL PRS resource set are applicable to all DL PRS resources in the resource set. Therefore, all DL PRS resources in the same DL PRS resource set are transmitted at the same periodicity with the same number of repetitive transmissions and occupy the same number of OFDM symbols.

Each DL PRS resource is configured with the following parameters:
An ID of a DL PRS resource (nr-DL-PRS-ResourceID);
A sequence ID of the DL PRS (dl-PRS-SequenceID).
A starting frequency-domain resource unit offset of the DL PRS (dl-PRS-CombSizeN-AndReOffset), defining a frequency-domain resource unit offset value used for resource mapping of the DL PRS resource to a first allocated OFDM symbol in a slot. Based on the parameter and the relative offset value specified in TS38.211, the UE determines the frequency-domain resource unit offset values used for resource mapping to each OFDM symbol.
A resource slot offset of the DL PRS (dl-PRS-ResourceSlotOffset), defining a slot offset relative to the DL PRS resource set. The slot position of each DL PRS resource is determined based on the parameter.
An OFDM symbol offset of the DL PRS (dl-PRS-ResourceSymbolOffset), defining a time-frequency resource allocation position of a DL PRS resource in a slot, and indicating a starting OFDM symbol index number in the slot.
Quasi co-location (QCL) information of the DL PRS (dl-PRS-QCL-Info), providing the QCL information of the DL PRS signal.

### 5. Sidelink Over Unlicensed Spectrum (SL-U)

In the SL-U, sidelink transmission needs to satisfy specific regulatory requirements, for example, a minimum occupied channel bandwidth (OCB) and a maximum power spectral density (PSD). For the OCB requirement, in a case where the UE transmits data over the channel, the OCB is not less than 80% of a bandwidth of a channel; and for the maximum PSD requirement, the transmit power of the UE per 1 MHz is not greater than 10 dBm. An interlaced resource block (IRB) structure is used in the SL-U to satisfy OCB and PSD regulatory requirements. An IRB includes N discrete RBs in the frequency domain, M IRBs are included in a frequency band range, and a number of RBs in an mth IRB is any one of {m, M+m, 2M+m, 3M+m, . . . }.

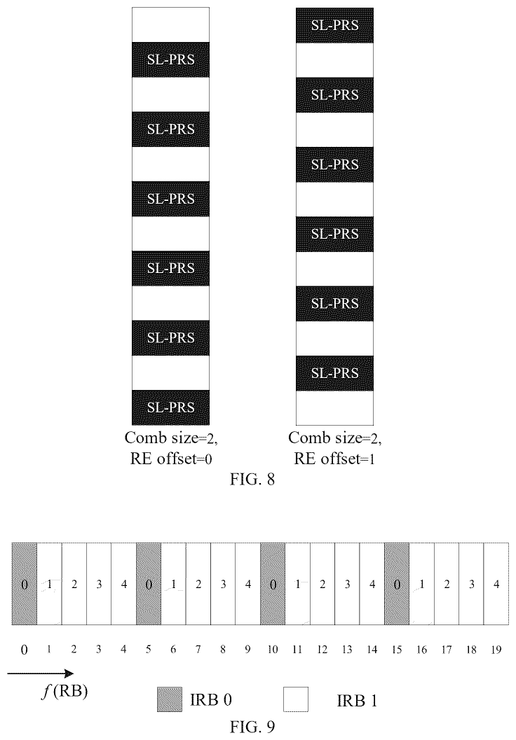

As illustrated in FIG. 9, the system bandwidth includes 20 RBs and five IRBs (that is, M=5), and each IRB includes four RBs (that is, N=4). The frequency-domain intervals of two adjacent RBs belonging to the same IRB are the same, that is, five RBs. The numbers in the boxes in the drawing represent the IRB index.

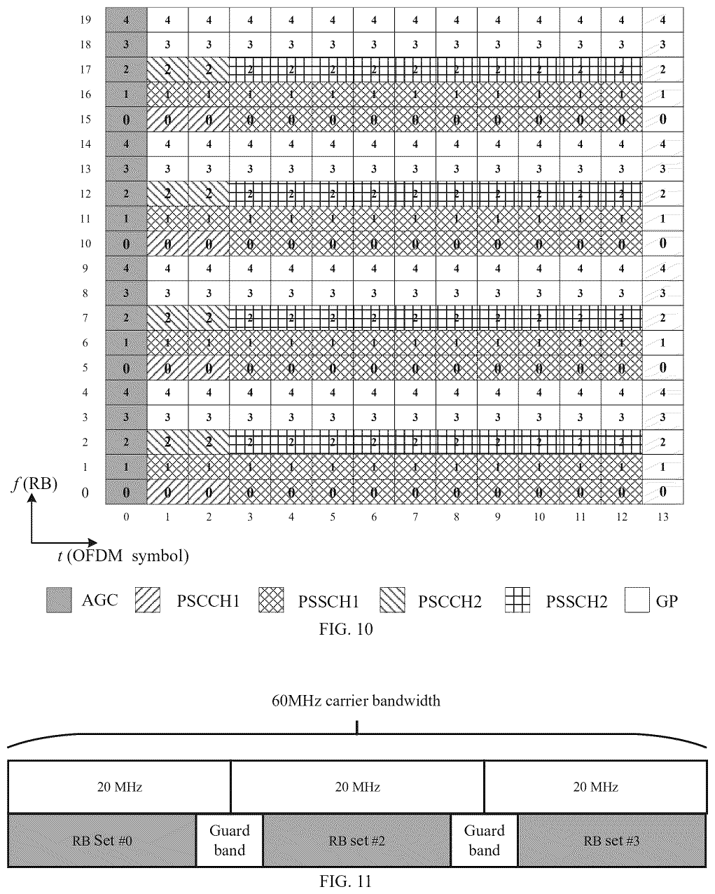

In the SL-U system, in a case where a resource allocation granularity is an IRB, the channels, for example, the PSCCH and the PSSCH, of the SL-U system are set based on the IRB structure. In this case, the frame structure of the SL-U system is illustrated in FIG. 10, and the numbers in the boxes in the drawing represent the IRB index. FIG. 10 is a schematic diagram of a frame structure of a slot that only includes a PSCCH and a PSSCH and does not include a PSFCH. The bandwidth illustrated in the drawing includes 20 RBs, and five IRB resources are configured (that is, M=5). Each IRB resource includes four RBs, and the numbers in the boxes in the drawing represent the IRB index. In FIG. 10, the system configures the PSCCH to occupy one IRB resource and two OFDM symbols in the time domain. The PSSCH takes an IRB as the granularity. The first symbol in the slot is an AGC symbol, and a last symbol is a GP symbol. In the drawing, PSSCH 1 occupies IRB #0 and IRB #1, and corresponding PSCCH 1 occupies IRB #0; and PSSCH 2 occupies IRB #2, and corresponding PSCCH 2 also occupies IRB #2. It should be noted that in the drawing, resources occupied by the second-stage SCI and resources occupied by the PSCCH DMRS and the PSSCH DMRS are not illustrated for the sake of simplification.

In the SL-U, the UE accesses the channel through listen before talk (LBT). The LBT takes a granularity of 20 MHz in the frequency domain. Every 20 MHz is referred to as an RB set. a carrier includes a plurality of RB sets, and a GP is present between RB sets, as illustrated in FIG. 11.

In the SL-U, the UE needs to perform LBT first, and accesses the channel upon the LBT. However, a time for the UE to perform the LBT is indefinite. In a case where the UE starts to transmit from a starting point of a slot, the UE may miss a transmission opportunity due to failure of the LBT. Therefore, in the SL-U, a transmission starting point is added into a slot, that is, multi-starting point transmission is set for the SL-U. For example, the additional starting point is the third or fourth OFDM symbol in the slot.

### 6 Sidelink-Based Positioning

In 3GPP R-17, 3GPP RAN researches “NR positioning enhancement” and “scenarios and requirements of NR position cases in a coverage, partially in a coverage, and beyond a coverage.” The “scenarios and requirements of NR position cases in a coverage, partially in a coverage, and beyond a coverage” focuses on V2X and public safety cases. Furthermore, the 3GPP SA1 working group has also formulated the requirements of “ranging-based services” and established the positioning accuracy requirements for the Industrial Internet of things (IIoT) beyond a coverage. 3GPP needs to research and develop sidelink positioning solutions to support cases, scenarios and requirements identified in the activities.

The 3GPP performs the feasibility and performance research of positioning based on the SPRS in the early stage of Rel-18 to improve the positioning accuracy, especially positioning of a UE beyond a cellular network coverage. Next, the solution based on sidelink positioning (including ranging/orientation) in the NR system is standardized.

In the sideline, different UEs transmits the SL PRS in occupying different time-frequency resources, and how to multiplex the PSCCH indicating transmission of SL PRS is an unsolved problem. In this case, the following embodiments of the present application provide a solution, which is elaborated in detail hereinafter. In addition, in the present disclosure, unless otherwise stated, all indexes/numbers are counted from 0.

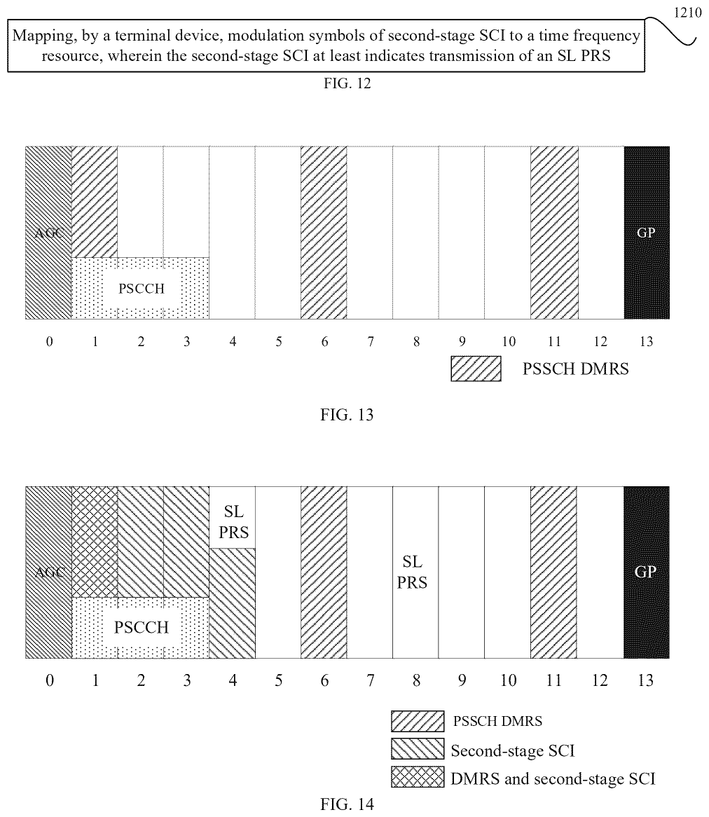

Referring to FIG. 12, FIG. 12 is a flowchart of a method for resource mapping according to some embodiments of the present disclosure. The method is applicable to the network architecture illustrated in FIG. 1, and is performed by a terminal device. The method is applicable to a licensed spectrum and an unlicensed spectrum. The method includes at least one of the following process.

In S1210, a terminal device maps modulation symbols of second-stage SCI to a time-frequency resource, wherein the second-stage SCI at least indicates transmission of an SL PRS.

The modulation symbols of second-stage SCI are acquired by modulating the second-stage SCI.

In some embodiments, the second-stage SCI only indicates transmission of the SL PRS.

In some embodiments, the second-stage SCI indicates transmission of the SL PRS and other contents. Illustratively, the second-stage SCI indicates transmission of the SL PRS and configuration information of the SL PRS. Illustratively, the second-stage SCI indicates transmission of the SL PRS and feedback information of the HARQ.

In some embodiments, the modulation symbols of the second-stage SCI are mapped to a time-frequency resource of the PSSCH. That is, the modulation symbols of the second-stage SCI are mapped to REs in the PSSCH.

In some embodiments, the modulation symbols of the second-stage SCI are mapped to REs that are not occupied. The REs that are not occupied refer to RE to which no information is mapped.

In some embodiments, the modulation symbols of the second-stage SCI are mapped to REs not occupied by at least one of the PSSCH DMRS, the SL PRS, the PSCCH, the PSCCH DMRS, or the PT-RS. Illustratively, the modulation symbols of the second-stage SCI are mapped to REs not occupied by the PSSCH DMRS, that is, the modulation symbols of the second-stage SCI and the PSSCH DMRS are not concurrently mapped to an RE, the modulation symbols of the second-stage SCI are not mapped to REs to which the PSSCH DMRS is mapped. Illustratively, the modulation symbols of the second-stage SCI are mapped to REs not occupied by the PSSCH DMRS and the SL PRS, that is, the modulation symbols of the second-stage SCI are not mapped to REs occupied by the PSSCH DMRS and/or the SL PRS. It should be noted that the PT-RS in the embodiments of the present disclosure may be not present in a carrier transmitted through the SL PRS, and the PSCCH in the embodiments of the present disclosure includes the PSCCH DMRS, which are not described herein any further.

In some embodiments, the modulation symbols of the second-stage SCI are mapped to REs not occupied by the PSSCH DMRS, the PSCCH, the PSCCH DMRS, and the PT-RS on OFDM symbols not containing the SL PRS. Illustratively, as illustrated in FIG. 13, in a case where the SL PRS is mapped to a second OFDM symbol, the modulation symbols of the second-stage SCI are mapped to REs not occupied by the PSSCH DMRS, the PSCCH, the PSCCH DMRS, and the PT-RS on OFDM symbols not containing the SL PRS, that is, the modulation symbols of the second-stage SCI are mapped to REs not occupied by the PSSCH DMRS, the PSCCH, the PSCCH DMRS, and the PT-RS on OFDM symbols other than the second OFDM symbol. The REs not occupied by the PSSCH DMRS, the PSCCH, the PSCCH DMRS, and the PT-RS refer to REs not occupied by any one or more of the PSSCH DMRS, the PSCCH, the PSCCH DMRS, and the PT-RS, that is, REs to which any one of the PSSCH DMRS, the PSCCH, the PSCCH DMRS, and the PT-RS is not mapped.

In some embodiments, the SL PRS is mapped to REs not occupied by the PSCCH, the PSCCH DMRS, the second-stage SCI, and the PT-RS on OFDM symbols not containing the SL PRS. Illustratively, as illustrated in FIG. 13, in a case where the PSSCH DMRS is mapped to the first symbol, the sixth symbol, and the eleventh symbol, the SL PRS is mapped to REs not occupied by the PSCCH, the PSCCH DMRS, the second-stage SCI, and the PT-RS on OFDM symbols not containing the SL PRS, that is, the SL PRS is mapped to REs not occupied by the PSCCH, the PSCCH DMRS, the second-stage SCI, and the PT-RS on OFDM symbols other than the first symbol, the sixth symbol, and the eleventh symbol. The REs not occupied by the PSCCH, the PSCCH DMRS, the second-stage SCI, and the PT-RS refer to REs not occupied by any one or more of the PSCCH, the PSCCH DMRS, the second-stage SCI, and the PT-RS, that is, REs to which any one of the PSCCH, the PSCCH DMRS, the second-stage SCI, and the PT-RS is not mapped.

In some embodiments, the SL PRS is mapped to OFDM symbols not containing at least one of the PSSCH DMRS, the PSCCH, or the second-stage SCI. Illustratively, as illustrated in FIG. 13, the PSSCH DMRS is mapped to the first symbol, the sixth symbol, and the eleventh symbol, the PSCCH is mapped to the first symbol, the second symbol, and the third symbol, the SL PRS is mapped to OFDM symbols not containing at least one of the PSSCH DMRS, the PSCCH, or the second-stage SCI in a case where the second-stage SCI is mapped to the first symbol, the second symbol, the third symbol, and the fourth symbol, that is, the SL PRS is mapped to OFDM symbols other than the first symbol, the second symbol, the third symbol, and the fourth symbol, the sixth symbol, and the eleventh symbol.

In some embodiments, the SL PRS is mapped to REs not occupied by at least one of the PSSCH DMRS, the second-stage SCI, the PSCCH, the PSCCH DMRS, or the PT-RS. Illustratively, the SL PRS is mapped to REs not occupied by the PSSCH DMRS, that is, the SL PRS and the PSSCH DMRS are not concurrently mapped to an RE, the SL PRS is not mapped to REs to which the PSSCH DMRS is mapped. Illustratively, the SL PRS is mapped to REs not occupied by the PSSCH DMRS and the second-stage SCI, that is, the SL PRS is not mapped to REs occupied by the PSSCH DMRS and/or the second-stage SCI.

Rate matching refers to a digital-domain processing procedure of aligning a number of encoded bits with an actual number of available transmission resources. In the embodiments of the present disclosure, a rate matching mechanism is adopted to align a number of modulation symbols of the second-stage SCI with the actual number of available transmission resources.

In some embodiments, a rate matching mechanism of the second-stage SCI ensures that the modulation symbols of the second-stage SCI occupy all REs available for mapping of the second-stage SCI in a first OFDM symbol on the first mapping OFDM symbol. Illustratively, as illustrated in FIG. 13, the rate matching mechanism of the second-stage SCI ensures that the modulation symbols of the second-stage SCI occupy all REs available for mapping of the second-stage SCI in any OFDM symbol on the any mapping OFDM symbol. After a last modulation symbol of the second-stage SCI is mapped, in a case where an OFDM symbol of the modulation symbol includes an RE that satisfies mapping of the SL PRS and is not a first OFDM symbol to which the modulation symbols of the second-stage SCI are mapped, the SL PRS is still mapped to the OFDM symbol. For example, the modulation symbols of the second-stage SCI are mapped to the first OFDM symbol to the fourth OFDM symbol, and the rate matching mechanism ensures that the modulation symbols of the second-stage SCI occupy all REs available for mapping of the second-stage SCI on the first OFDM symbol. After the modulation symbols of the second-stage SCI are mapped, in a case where the fourth OFDM symbol still includes an RE available for mapping of the SL PRS, the SL PRS is still mapped to the fourth OFDM symbol.

In some embodiments, a rate matching mechanism of the second-stage SCI ensures that the modulation symbols of the second-stage SCI occupy all REs available for mapping of the second-stage SCI in any OFDM symbol on the any mapping OFDM symbol, such that a code rate is reduced. Illustratively, as illustrated in FIG. 13, the rate matching mechanism of the second-stage SCI ensures that the modulation symbols of the second-stage SCI occupy all REs available for mapping of the second-stage SCI in any OFDM symbol on the any OFDM symbol to which the second-stage SCI is mapped. For example, the modulation symbols of the second-stage SCI are mapped to the first OFDM symbol to the fourth OFDM symbol, and the rate matching mechanism ensures that the modulation symbols of the second-stage SCI occupy all REs available for mapping of the second-stage SCI on the first OFDM symbol, the second OFDM symbol, the third OFDM symbol, and the fourth OFDM symbol.

In some embodiments, in a case where the modulation symbols of the second-stage SCI determined based on a rate matching mechanism of the second-stage SCI do not completely occupy all REs available for mapping of the second-stage SCI in OFDM symbols that need to be occupied, the modulation symbols of the second-stage SCI are repeatedly mapped to non-occupied REs available for mapping of the second-stage SCI in the OFDM symbols that need to be occupied.

The OFDM symbols that need to be occupied include at least one of: the first OFDM symbol, the OFDM symbol containing the PSCCH, the OFDM symbol containing the PSSCH DMRS, or the OFDM symbol containing the PSCCH and the OFDM symbol containing the PSSCH DMRS.

In some embodiments, in a case where a PSSCH DMRS or a PSCCH DMRS is determined as a reference signal for measuring an SL reference signal received power (RSRP) in a resource pool in a resource monitoring process, the terminal device transmits the PSSCH DMRS. Illustratively, in a case where a PSSCH DMRS is determined as a reference signal for measuring an SL RSRP in a resource pool in a resource monitoring process, the terminal device transmits the PSSCH DMRS; or, in a case where a PSCCH DMRS is determined as a reference signal for measuring an SL RSRP in a resource pool in a resource monitoring process, the terminal device transmits the PSSCH DMRS.

In some embodiments, the terminal device transmits all PSSCH DMRSs in a selected PSSCH DMRS pattern.

The PSSCH DMRS pattern refers to a position of the PSSCH DMRS in an OFDM symbol in a slot, and the PSSCH DMRS patterns are determined based on Table 2, which are not enumerated in the present disclosure herein.

In some embodiments, no matter whether the PSSCH DMRS or the PSCCH DMRS is determined as the reference signal for measuring the SL RSRP in the resource pool in the resource monitoring process, the terminal device transmits all PSSCH DMRSs in the selected PSSCH DMRS pattern, such that the accuracy of channel estimation is improved.

In some embodiments, in a case where a PSSCH DMRS is determined as a reference signal for measuring an SL RSRP in a resource pool in a resource monitoring process, the terminal device transmits part of PSSCH DMRSs in a selected PSSCH DMRS pattern, such that time-frequency resources occupied by the PSSCH DMRSs are reduced.

In some embodiments, REs available for the PSSCH, the PSCCH, the PSSCH DMRS, the PT-RS or the SL PRS in the first OFDM symbol need to be duplicated to an OFDM symbol before the first OFDM symbol. That is, information carried in the OFDM symbol before the first OFDM symbol is the same as information carried in the first OFDM symbol. Illustratively, as illustrated in FIG. 13, REs available for the PSSCH, the PSCCH, the PSSCH DMRS, the PT-RS or the SL PRS in the first OFDM symbol need to be duplicated to a 0^{th} OFDM symbol (the AGC). That is, information carried in the 0^{th} OFDM symbol is the same as information carried in the first OFDM symbol.

In some embodiments, the second-stage SCI is first mapped to the OFDM symbols, and then the SL PRS is mapped to the OFDM symbols.

In some embodiments, the SL PRS is first mapped to the OFDM symbols, and then the second-stage SCI is mapped to the OFDM symbols.

In some embodiments, methods for mapping the modulation symbols of the second-stage SCI to time-frequency resources are described in several exemplary embodiments.

In some embodiments, the modulation symbols of the second-stage SCI are mapped starting from a first OFDM symbol containing a PSSCH DMRS.

In some embodiments, the modulation symbols of the second-stage SCI are sequentially mapped, in a sequence of first frequency domain and then time domain, to REs of at least one allocated virtual resource block starting from the first OFDM symbol containing the PSSCH DMRS in accordance with an ascending order of indexes.

In some embodiments, the modulation symbols of the second-stage SCI are at least mapped to all OFDM symbols containing a PSCCH.

In some embodiments, the modulation symbols of the second-stage SCI are sequentially mapped, in a sequence of first frequency domain and then time domain, to REs of at least one allocated virtual resource block starting from a first OFDM symbol containing the PSCCH in accordance with an ascending order of indexes.

In some embodiments, the terminal device expects that a resource pool is configured with at least one PSSCH DMRS pattern with a PSSCH DMRS present on a first OFDM symbol, and the terminal device selects the PSSCH DMRS pattern with a PSSCH DMRS present on the first OFDM symbol. For example, the terminal device selects the PSSCH DMRS patterns with the PSSCH DMRS present on the first OFDM symbol, the sixth OFDM symbol, and the eleventh OFDM symbol. For example, the terminal device selects the PSSCH DMRS patterns with the PSSCH DMRS present on the first OFDM symbol, the fourth OFDM symbol, the seventh OFDM symbol, and the tenth OFDM symbol. For example, the terminal device does not select the PSSCH DMRS patterns with the PSSCH DMRS present on the third OFDM symbol and the tenth OFDM symbol.

In some embodiments, in a case where a first OFDM symbol does not contain a PSSCH DMRS, the modulation symbols of the second-stage SCI are at least mapped to an OFDM symbol containing a PSSCH DMRS pattern.

In some embodiments, the modulation symbols of the second-stage SCI are at least mapped to all OFDM symbols containing a PSSCH DMRS.

In some embodiments, the modulation symbols of the second-stage SCI are sequentially mapped, in a sequence of first frequency domain and then time domain, to REs of the OFDM symbols containing the PSSCH DMRS in at least one allocated virtual resource block starting from a first OFDM symbol containing the PSSCH DMRS in accordance with an ascending order of indexes.

In some embodiments, in a case where a number of the modulation symbols of the second-stage SCI is greater than a number of REs available for mapping of the second-stage SCI in the OFDM symbols containing the PSSCH DMRS, remaining modulation symbols of the second-stage SCI are sequentially mapped, in a sequence of first frequency domain and then time domain, to REs of the at least one allocated virtual resource block starting from a first OFDM symbol not containing the PSSCH DMRS in accordance with an ascending order of indexes.

In some embodiments, the modulation symbols of the second-stage SCI are at least mapped to all OFDM symbols containing a PSCCH and all OFDM symbols containing a PSSCH DMRS.

In some embodiments, the modulation symbols of the second-stage SCI are sequentially mapped, in a sequence of first frequency domain and then time domain, to REs of the OFDM symbols containing the PSSCH DMRS in at least one allocated virtual resource block starting from a first OFDM symbol containing the PSSCH DMRS in accordance with an ascending order of indexes, and then are sequentially mapped, in the sequence of first frequency domain and then time domain, to REs of the at least one allocated virtual resource block starting from a first OFDM symbol not containing the PSSCH DMRS and containing the PSCCH in accordance with the ascending order of indexes.

In some embodiments, the modulation symbols of the second-stage SCI are sequentially mapped, in a sequence of first frequency domain and then time domain, to REs of at least one allocated virtual resource block starting from a first OFDM symbol containing the PSCCH in accordance with an ascending order of indexes, and then are mapped, in the sequence of first frequency domain and then time domain, to REs of the OFDM symbols containing the PSSCH DMRS in at least one allocated virtual resource block starting from a first OFDM symbol not containing the PSCCH but containing the PSSCH DMRS in accordance with the ascending order of indexes.

In some embodiments, the modulation symbols of the second-stage SCI are sequentially mapped, in a sequence of first frequency domain and then time domain, to REs of the OFDM symbols containing the PSSCH DMRS in at least one allocated virtual resource block starting from a first OFDM symbol containing the PSSCH DMRS and/or the PSCCH in accordance with an ascending order of indexes.

In some embodiments, the modulation symbols of the second-stage SCI are only mapped to OFDM symbols containing a PSSCH DMRS.

In some embodiments, the modulation symbols of the second-stage SCI are sequentially mapped, in a sequence of first frequency domain and then time domain, to REs of the OFDM symbols containing the PSSCH DMRS in at least one allocated virtual resource block starting from a first OFDM symbol containing the PSSCH DMRS in accordance with an ascending order of indexes.

In some embodiments, a modulation mode of the modulation symbols of the second-stage SCI is determined based on a comb size of the SL PRS.

In some embodiments, in a case where the comb size of the SL PRS is greater than 2, the modulation symbols of the second-stage SCI are mapped to REs not occupied by the SL PRS on OFDM symbols containing the SL PRS.

In some embodiments, in a case where the comb size of the SL PRS is equal to 2, the modulation symbols of the second-stage SCI are mapped to REs not occupied by the SL PRS and the PSSCH DMRS.

In some embodiments, in a case where the comb size of the SL PRS is equal to 1, the modulation symbols of the second-stage SCI are mapped to OFDM symbols containing the PSSCH DMRS.

In the technical solutions according to the embodiments of the present disclosure, the second-stage SCI used to indicate the transmission of SL PRS are mapped to the allocated time-frequency resource. In a case where the SL PRS and the second-stage SCI are transmitted in the shared resource pool, the second-stage SCI is effectively received, and the effect on resource selection of the receiver terminal device is reduced.

The several exemplary embodiments of the methods for mapping the modulation symbols of the second-stage SCI to time-frequency resources are described in detail in the present disclosure.

First, the modulation symbols of the second-stage SCI are mapped starting from a first OFDM symbol containing a PSSCH DMRS.

In some embodiments, the modulation symbols of the second-stage SCI are sequentially mapped, in the sequence of first frequency domain and then time domain, to REs of the at least one allocated virtual resource block starting from the first OFDM symbol containing the PSSCH DMRS in accordance with the ascending order of indexes.

In some embodiments, the method in the embodiments are performed on the premise that the terminal device transmits the PSSCH DMRS in a case where the PSSCH DMRS or the PSCCH DMRS is determined as the reference signal for measuring an SL RSRP in the resource pool in the resource monitoring process.

That is, no matter whether the PSSCH DMRS or the PSCCH DMRS is determined as the reference signal for measuring the SL RSRP in the resource pool in the resource monitoring process, the terminal device transmits the PSSCH DMRS.

In some embodiments, the terminal device transmits all PSSCH DMRSs in the selected PSSCH DMRS pattern, such that the accuracy of channel estimation is improved.

In some embodiments, in a case where the PSSCH DMRS is determined as the reference signal for measuring the SL RSRP in the resource pool in the resource monitoring process, the terminal device transmits part of DMRSs in the selected PSSCH DMRS pattern, such that the time-frequency resources occupied by the PSSCH DMRSs are reduced.

Illustratively, in a case where the PSSCH DMRS patterns selected by the terminal device include PSSCH DMRS patterns of three OFDM symbols, the terminal device transmits PSSCH DMRS patterns of one or two of the three OFDM symbols, or transmits PSSCH DMRS patterns of the three OFDM symbols.

(1) The terminal device first maps the second-stage SCI, and then maps the SL PRS.

The terminal device sequentially maps, in the sequence of first frequency domain and then time domain, the modulation symbols of the second-stage SCI to REs of the at least one allocated virtual resource block starting from the first OFDM symbol containing the PSSCH DMRS in accordance with the ascending order of indexes. The modulation symbols of the second-stage SCI are mapped to REs not occupied by at least one of the PSSCH DMRS, the PSCCH, the PSCCH DMRS, or the PT-RS.

In some embodiments, the PSSCH only carries the second-stage SCI, and the rate matching mechanism of the second-stage SCI is at least one of:

1. The rate matching mechanism of the second-stage SCI ensures that the modulation symbols of the second-stage SCI occupy all REs available for mapping of the second-stage SCI in a first OFDM symbol on the first mapping OFDM symbol. As illustrated in FIG. 14, in a case where the modulation symbols of the second-stage SCI are mapped by the following process, the last modulation symbol of the second-stage SCI is mapped, and the OFDM symbol (the fourth OFDM symbol) of the modulation symbol contains the RE available for mapping of the second-stage SCI and does not contain the PSSCH DMRS, the terminal device transmits the SL PRS on the remaining REs.

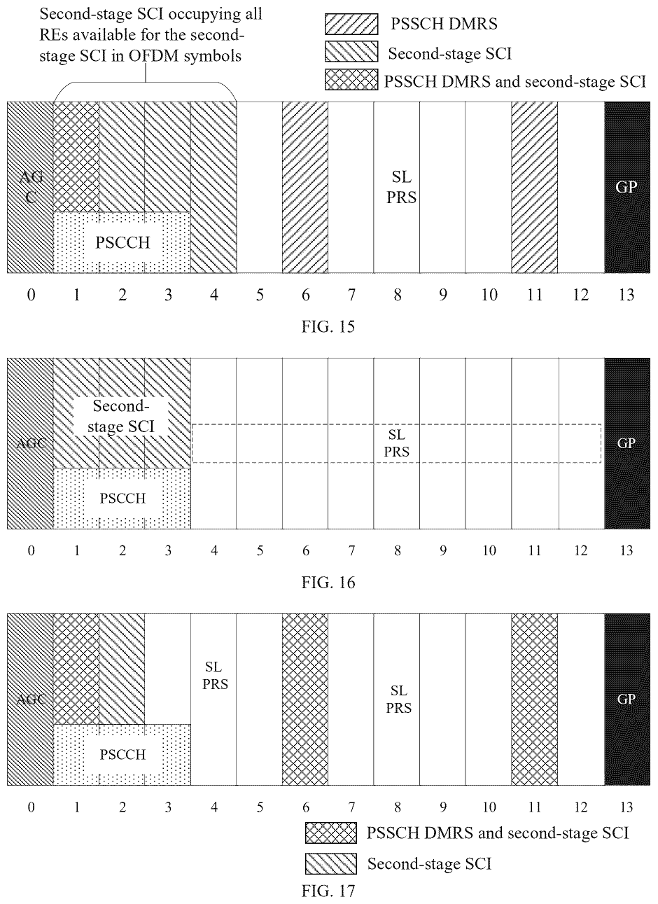

2. The rate matching mechanism of the second-stage SCI ensures that the modulation symbols of the second-stage SCI occupy all REs available for mapping of the second-stage SCI in any OFDM symbol on the any mapping OFDM symbol, such that a code rate is reduced. As illustrated in FIG. 15, in a case where the modulation symbols of the second-stage SCI are mapped by the following process, after the last modulation symbol of the second-stage SCI is mapped, the RE available for mapping of the second-stage SCI on the OFDM symbol (the fourth OFDM symbol) of the modulation symbol are occupied.

3. In a case where the modulation symbols of the second-stage SCI determined based on the rate matching mechanism of the second-stage SCI do not completely occupy all REs available for mapping of the second-stage SCI in OFDM symbols that need to be occupied, the modulation symbols of the second-stage SCI are repeatedly mapped to non-occupied REs available for mapping of the second-stage SCI in the OFDM symbols that need to be occupied.

After the second-stage SCI is mapped, the terminal device maps the SL PRS to REs not occupied by the PSCCH and the second-stage SCI on the OFDM symbols not containing the PSSCH DMRS.

In some embodiments, the terminal device maps the virtual resource block to the physical resource block in a non-interleaving mode. That is, the virtual resource block n is mapped to the physical resource block n. n represents an index of the virtual resource block or the physical resource block, and n is an integer greater than or equal to 0.

The virtual resource block refers to a resource allocated by a high layer for information transmission, and the physical layer adopts the physical resource block to carry information that needs to be transmitted.

(2) The terminal device first maps the SL PRS, and then maps the second-stage SCI.

In this case, the terminal device occupies REs unavailable for the SL PRS on the OFDM symbols containing the SL PRS and transmits the modulation symbols of the second-stage SCI, or the second-stage SCI punches the SL PRS on the OFDM symbols containing the SL PRS. The punching of the second-stage SCI means that the modulation symbols of the second-stage SCI are mapped to the OFDM symbols containing the SL PRS, and REs for mapping the modulation symbols of the second-stage SCI are not occupied by the SL PRS.

The terminal device first maps the SL PRS to the at least one allocated virtual resource block, and then maps the modulation symbols of the second-stage SCI to the at least one allocated virtual resource block. The OFDM symbol to which the SL PRS is mapped, the comb size of the SL PRS, and the RE offset are indicated by the high layer signaling or first-stage SCI. The high layer signaling includes at least one of: a configured signaling, a pre-configured signaling, or a signaling on a physical layer for interaction between terminal devices.

For example, the OFDM symbol to which the SL PRS is mapped includes all OFDM symbols in the allocated resource other than the OFDM symbol containing the PSSCH DMRS, and OFDM symbols after the first PSSCH DMRS are excluded based on configuration or pre-configuration of the resource pool or dynamic indication of the terminal device.

In some embodiments, the SL PRS is not mapped to the OFDM symbol containing the PSSCH DMRS, the virtual resource block containing the PSCCH, or the RE containing the PT-RS.

Upon completion of mapping of the SL PRS, the terminal device sequentially maps, in the sequence of first frequency domain and then time domain, the modulation symbols of the second-stage SCI to REs of the at least one allocated virtual resource block starting from the first OFDM symbol containing the PSSCH DMRS in accordance with the ascending order of indexes, and the REs to which the modulation symbols of the second-stage SCI are mapped are not occupied by any one of the PSSCH DMRS, the SL PRS, the PSCCH, the PSCCH DMRS, and the PT-RS.

In some embodiments, in a case where above resource is not efficient for carrying the modulation symbols of the second-stage SCI, the terminal device maps, in the sequence of first frequency domain and then time domain, remaining modulation symbols of the second-stage SCI to REs occupied by the SL PRS starting from an OFDM symbol N in accordance with the ascending order of indexes. The OFDM symbol N refers to a first OFDM symbol containing the SL PRS after the first OFDM symbol containing the PSSCH DMRS.

In some embodiments, the terminal device further maps the virtual resource block to the physical resource block in a non-interleaving mode. That is, the virtual resource block n is mapped to the physical resource block n. n represents an index of the virtual resource block or the physical resource block, and n is an integer greater than or equal to 0.

The method for mapping the second-stage SCI is different from the method for mapping the second-stage SCI in the current standards where the transmitter UE indicates the method for mapping the second-stage SCI of the receiver UE by setting a second-to-last least significant bit (LSB) in the reserved bit of SCI format 1-A as 1.

In the above method, the modulation symbols of the second-stage SCI used to indicate transmission of the SL PRS are mapped starting from the first OFDM symbol containing the PSCCH DMRS, such that the second-stage SCI is effectively received in a case where the SL PRS and the second-stage SCI are transmitted in the shared resource pool, and the effect on resource selection of the receiver terminal device is reduced. In this way, the mechanisms stipulated in the current standards are reused without the need to new mechanisms.

Second, the modulation symbols of the second-stage SCI are at least mapped to all OFDM symbols containing a PSCCH.

In some embodiments, the modulation symbols of the second-stage SCI are sequentially mapped, in the sequence of first frequency domain and then time domain, to REs of the at least one allocated virtual resource block starting from the first OFDM symbol containing the PSCCH in accordance with the ascending order of indexes.

In some embodiments, the terminal device expects that the resource pool is configured with at least one PSSCH DMRS pattern with the PSSCH DMRS present on the first OFDM symbol, and the terminal device selects the PSSCH DMRS pattern with the PSSCH DMRS present on the first OFDM symbol.

In some embodiments, in a case where a first OFDM symbol does not contain a PSSCH DMRS, the modulation symbols of the second-stage SCI are at least mapped to an OFDM symbol containing a PSSCH DMRS pattern.

In a case where the PSSCH only carries the second-stage SCI, the rate matching mechanism of the second-stage SCI ensures that the modulation symbols of the second-stage SCI occupy all REs available for mapping of the second-stage SCI in any OFDM symbol on the any mapping OFDM symbol and at least occupy all REs available for mapping of the second-stage SCI in the OFDM symbol containing the PSCCH, such that the terminal device does not need to transmit the SL PRS in the OFDM symbol containing the PSCCH, and the code rate is reduced. As illustrated in FIG. 16, the modulation symbols of the second-stage SCI occupy all REs available for mapping of the second-stage SCI on the OFDM symbols (the first OFDM symbol, the second OFDM symbol, and the third OFDM symbol) containing the PSCCH, the terminal device does not need to transmit the SL PRS in the OFDM symbol containing the PSCCH.

In a case where the modulation symbols of the second-stage SCI determined based on the rate matching mechanism of the second-stage SCI do not completely occupy all REs available for mapping of the second-stage SCI in OFDM symbols that need to be occupied, the modulation symbols of the second-stage SCI are repeatedly mapped to non-occupied REs available for mapping of the second-stage SCI in the OFDM symbols that need to be occupied. That is, in a case where the modulation symbols of the second-stage SCI do not completely occupy all REs available for the second-stage SCI in OFDM symbols containing the PSCCH, the terminal device repeatedly maps the second-stage SCI to remaining REs until all REs available for the second-stage SCI in the OFDM symbols containing the PSCCH are completely occupied. As illustrated in FIG. 16, in a case where the modulation symbols of the second-stage SCI do not completely occupy all REs available for the second-stage SCI in the first OFDM symbol, the second OFDM symbol, and the third OFDM symbol, the terminal device repeatedly maps the second-stage SCI to remaining REs until all REs available for the second-stage SCI in the first OFDM symbol, the second OFDM symbol, and the third OFDM symbol are completely occupied.

(1) In a case where the PSSCH DMRS is determined as the reference signal for measuring the SL RSRP in the resource pool, the terminal device transmits the PSSCH DMRS. That is, in a case where a PSCCH DMRS is determined as the reference signal for measuring the SL RSRP in the resource pool in the resource monitoring process, the terminal device does not transmit the PSSCH DMRS.

In some embodiments, the terminal device first maps the SL PRS, and then maps the second-stage SCI.

The terminal device first maps the SL PRS to the at least one allocated virtual resource block, and then maps the modulation symbols of the second-stage SCI to the at least one allocated virtual resource block. The OFDM symbol to which the SL PRS is mapped does not include the OFDM symbol containing the PSSCH DMRS and the OFDM symbol containing the PSCCH. In some embodiments, the comb size of the SL PRS and the RE offset are indicated by the high layer signaling or the first-stage SCI. The high layer signaling includes at least one of: the configured signaling, the pre-configured signaling, or the signaling on the physical layer for interaction between terminal devices.

In some embodiments, the SL PRS is not mapped to the RE containing the PT-RS.

Upon completion of mapping of the SL PRS, the terminal device sequentially maps, in the sequence of first frequency domain and then time domain, the modulation symbols of the second-stage SCI to REs of the at least one allocated virtual resource block starting from the first OFDM symbol (that is, the first OFDM symbol containing the PSCCH) in accordance with the ascending order of indexes, and the REs to which the modulation symbols of the second-stage SCI are mapped are not occupied by at least one of the PSSCH DMRS, the PSCCH, the PSCCH DMRS, the SL PRS, or the PT-RS.

In some embodiments, the terminal device maps the modulation symbols of the second-stage SCI to REs not occupied by the SL PRS in the OFDM symbols containing the SL PRS.

In some embodiments, the terminal device further maps the virtual resource block to the physical resource block in a non-interleaving mode. That is, the virtual resource block n is mapped to the physical resource block n. n represents an index of the virtual resource block or the physical resource block, and n is an integer greater than or equal to 0.

In the embodiments, the receiver terminal device demodulates the second-stage SCI using the SL PRS and/or the PSSCH DMRS.

(2) No matter whether the PSSCH DMRS or the PSCCH DMRS is determined as the reference signal for measuring the SL RSRP in the resource pool in the resource monitoring process, the terminal device transmits the PSSCH DMRSs.

In some embodiments, the terminal device transmits all PSSCH DMRSs in the selected PSSCH DMRS pattern, such that the accuracy of channel estimation is improved.

In some embodiments, in a case where a PSSCH DMRS is determined as a reference signal for measuring an SL RSRP in a resource pool in a resource monitoring process, the terminal device transmits part of PSSCH DMRSs in a selected PSSCH DMRS pattern, such that time-frequency resources occupied by the PSSCH DMRSs are reduced.

Illustratively, in a case where the PSSCH DMRS patterns selected by the terminal device include PSSCH DMRS patterns of three OFDM symbols, the terminal device transmits PSSCH

In some embodiments, the terminal device first maps the second-stage SCI, and then maps the SL PRS.

The terminal device sequentially maps, in the sequence of first frequency domain and then time domain, the modulation symbols of the second-stage SCI to REs of the at least one allocated virtual resource block starting from the first OFDM symbol (that is, the first OFDM symbol containing the PSCCH) in accordance with the ascending order of indexes. The REs for mapping the modulation symbols of the second-stage SCI are not occupied by at least one of the PSSCH DMRS, the PSCCH, the PSCCH DMRS, the SL PRS, or the PT-RS.

After the second-stage SCI is mapped, the terminal device starts to map the SL PRS. The OFDM symbols to which the SL PRS is mapped do not include the OFDM symbol containing the PSSCH DMRS, the OFDM symbol containing the PSCCH, and the OFDM symbol containing the second-stage SCI, such that transmission of signal with different power spectral densities on the same OFDM symbol by the terminal device is avoided.

In some embodiments, the terminal device first maps the SL PRS, and then maps the second-stage SCI.

The terminal device first maps the SL PRS to the at least one allocated virtual resource block. The OFDM symbol to which the SL PRS is mapped does not include at least one of the OFDM symbol containing the PSSCH DMRS or the OFDM symbol containing the PSCCH. In some embodiments, the comb size of the SL PRS and the RE offset are indicated by the high layer signaling or the first-stage SCI. The high layer signaling includes at least one of: the configured signaling, the pre-configured signaling, or the signaling on the physical layer for interaction between terminal devices.

Upon completion of mapping of the SL PRS, the terminal device sequentially maps, in the sequence of first frequency domain and then time domain, the modulation symbols of the second-stage SCI to REs of the at least one allocated virtual resource block starting from the first OFDM symbol (that is, the first OFDM symbol containing the PSCCH) in accordance with the ascending order of indexes, and the REs to which the modulation symbols of the second-stage SCI are mapped are not occupied by at least one of the PSSCH DMRS, the PSCCH, the PSCCH DMRS, the SL PRS, or the PT-RS.

In some embodiments, the OFDM symbols to which the modulation symbols of the second-stage SCI are mapped do not include the SL PRS, such that transmission of signal with different power spectral densities on the same OFDM symbol by the terminal device is avoided.

In some embodiments, the terminal device further maps the virtual resource block to the physical resource block in a non-interleaving mode. That is, the virtual resource block n is mapped to the physical resource block n. n represents an index of the virtual resource block or the physical resource block, and n is an integer greater than or equal to 0.

In some embodiments, the terminal device expects that the resource pool is configured with at least one PSSCH DMRS pattern with the PSSCH DMRS present on the first OFDM symbol, and the terminal device selects the PSSCH DMRS pattern with the PSSCH DMRS present on the first OFDM symbol.

In some embodiments, in a case where a first OFDM symbol does not contain a PSSCH DMRS, the second-stage SCI occupies at least an OFDM symbol containing the PSSCH DMRS pattern.

The method for mapping the second-stage SCI is different from the method for mapping the second-stage SCI in the current standards where the transmitter UE indicates the method for mapping the second-stage SCI of the receiver UE by setting a second-to-last LSB in the reserved bit of SCI format 1-A as 1.

In the above method, the modulation symbols of the second-stage SCI used to indicate transmission of the SL PRS are at least mapped to all OFDM symbols containing the PSCCH, such that the second-stage SCI is effectively received in a case where the SL PRS and the second-stage SCI are transmitted in the shared resource pool, and the effect on resource selection of the receiver terminal device is reduced. In addition, frequency-division multiplexing of the second-stage SCI and the PSCCH avoids frequency-division multiplexing of the SL PRS and the PSCCH.

Third, the modulation symbols of the second-stage SCI are at least mapped to all OFDM symbols containing a PSSCH DMRS.

No matter whether the PSSCH DMRS or the PSCCH DMRS is determined as the reference signal for measuring the SL RSRP in the resource pool in the resource monitoring process, the terminal device transmits the PSSCH DMRSs.

In some embodiments, the terminal device transmits all PSSCH DMRSs in the selected PSSCH DMRS pattern, such that the accuracy of channel estimation is improved.

In some embodiments, in a case where the PSCCH DMRS is determined as the reference signal for measuring the SL RSRP in the resource pool in the resource monitoring process, the terminal device transmits part of PSSCH DMRSs in the selected PSSCH DMRS pattern, such that time-frequency resources occupied by the PSSCH DMRSs are reduced.

Illustratively, in a case where the PSSCH DMRS patterns selected by the terminal device include PSSCH DMRS patterns of three OFDM symbols, the terminal device transmits PSSCH DMRS patterns of one or two of the three OFDM symbols, or transmits PSSCH DMRS patterns of the three OFDM symbols.

In some embodiments, the terminal device first maps the second-stage SCI, and then maps the SL PRS.

The terminal device sequentially maps, in the sequence of first frequency domain and then time domain, the modulation symbols of the second-stage SCI to REs of the OFDM symbols containing the PSSCH DMRS in the at least one allocated virtual resource block starting from the first OFDM symbol containing the PSSCH DMRS in accordance with the ascending order of indexes, and the REs to which the modulation symbols of the second-stage SCI are mapped are not occupied by at least one of the PSSCH DMRS, the PSCCH, the PSCCH DMRS, or the PT-RS.

In some embodiments, in a case where the PSSCH only carries the second-stage SCI, the rate matching mechanism of the second-stage SCI ensures that the number of the modulation symbols of the second-stage SCI is greater than or equal to the number of REs available for mapping of the second-stage SCI in the OFDM symbols containing the PSSCH DMRS.

In some embodiments, in a case where the modulation symbols of the second-stage SCI determined based on the rate matching mechanism of the second-stage SCI do not completely occupy all REs available for mapping of the second-stage SCI in OFDM symbols that need to be occupied, the modulation symbols of the second-stage SCI are repeatedly mapped to non-occupied REs available for mapping of the second-stage SCI in the OFDM symbols that need to be occupied. That is, in a case where the modulation symbols of the second-stage SCI do not completely occupy all REs available for the second-stage SCI in OFDM symbols containing the PSSCH DMRS, the terminal device repeatedly maps the second-stage SCI to remaining REs until all REs available for the second-stage SCI in the OFDM symbols containing the PSSCH DMRS are completely occupied.

In some embodiments, in a case where the number of the modulation symbols of the second-stage SCI is greater than the number of REs available for mapping of the second-stage SCI in the OFDM symbols containing the PSSCH DMRS, the terminal device sequentially maps, in the sequence of first frequency domain and then time domain, the modulation symbols of the second-stage SCI to REs in the at least one allocated virtual resource block starting from the first OFDM symbol not containing the PSSCH DMRS in accordance with the ascending order of indexes, and the REs to which the modulation symbols of the second-stage SCI are mapped are not occupied by at least one of the PSSCH DMRS, the PSCCH, the PSCCH DMRS, or the PT-RS. As illustrated in FIG. 17, in a case where the number of the modulation symbols of the second-stage SCI is greater than the number of REs available for mapping of the second-stage SCI in the OFDM symbols containing the PSSCH DMRS, the terminal device sequentially maps, in the sequence of first frequency domain and then time domain, the modulation symbols of the second-stage SCI to REs in the at least one allocated virtual resource block starting from the second OFDM symbol in accordance with the ascending order of indexes.

In some embodiments, the terminal device further maps the virtual resource block to the physical resource block in a non-interleaving mode. That is, the virtual resource block n is mapped to the physical resource block n. n represents an index of the virtual resource block or the physical resource block, and n is an integer greater than or equal to 0.

The method for mapping the second-stage SCI is different from the method for mapping the second-stage SCI in the current standards where the transmitter UE indicates the method for mapping the second-stage SCI of the receiver UE by setting a second-to-last LSB in the reserved bit of SCI format 1-A as 1.

In the above method, the modulation symbols of the second-stage SCI used to indicate transmission of the SL PRS are at least mapped to all OFDM symbols containing the PSSCH DMRS, such that the second-stage SCI is effectively received in a case where the SL PRS and the second-stage SCI are transmitted in the shared resource pool, and the effect on resource selection of the receiver terminal device is reduced.

Fourth, the modulation symbols of the second-stage SCI are at least mapped to all OFDM symbols containing a PSCCH and all OFDM symbols containing a PSSCH DMRS.

In the embodiments, the modulation symbols of the second-stage SCI are at least mapped to UEs of the OFDM symbols containing the PSCCH and the OFDM symbols containing the PSSCH DMRS, and the REs to which the modulation symbols of the second-stage SCI are mapped are not occupied by at least one of the PSSCH DMRS, the PSCCH, the PSCCH DMRS, or the PT-RS.

In some embodiments, the rate matching mechanism of the second-stage SCI ensures that the number of the modulation symbols of the second-stage SCI is greater than or equal to the number of REs available for mapping of the second-stage SCI in the OFDM symbols containing the PSCCH and the OFDM symbols containing the PSSCH DMRS.

In some embodiments, in a case where the modulation symbols of the second-stage SCI determined based on the rate matching mechanism of the second-stage SCI do not completely occupy all REs available for mapping of the second-stage SCI in OFDM symbols that need to be occupied, the modulation symbols of the second-stage SCI are repeatedly mapped to non-occupied REs available for mapping of the second-stage SCI in the OFDM symbols that need to be occupied. That is, in a case where the modulation symbols of the second-stage SCI do not completely occupy all REs available for the second-stage SCI in the OFDM symbols containing the PSCCH DMRS and the OFDM symbols containing the PSSCH DMRS, the terminal device repeatedly maps the second-stage SCI to remaining REs until all REs available for the second-stage SCI in the OFDM symbols containing the PSCCH DMRS and the OFDM symbols containing the PSSCH DMRS are completely occupied.

No matter whether the PSSCH DMRS or the PSCCH DMRS is determined as the reference signal for measuring the SL RSRP in the resource pool in the resource monitoring process, the terminal device transmits the PSSCH DMRSs.

In some embodiments, the terminal device transmits all PSSCH DMRSs in the selected PSSCH DMRS pattern, such that the accuracy of channel estimation is improved.

In some embodiments, in a case where the PSCCH DMRS is determined as the reference signal for measuring the SL RSRP in the resource pool in the resource monitoring process, the terminal device transmits part of PSSCH DMRSs in the selected PSSCH DMRS pattern, such that time-frequency resources occupied by the PSSCH DMRSs are reduced.

Illustratively, in a case where the PSSCH DMRS patterns selected by the terminal device include PSSCH DMRS patterns of three OFDM symbols, the terminal device transmits PSSCH

In some embodiments, the terminal device sequentially maps, in the sequence of first frequency domain and then time domain, the modulation symbols of the second-stage SCI to REs of the OFDM symbols containing the PSSCH DMRS in the at least one allocated virtual resource block starting from the first OFDM symbol containing the PSSCH DMRS in accordance with the ascending order of indexes, and the REs to which the modulation symbols of the second-stage SCI are mapped are not occupied by at least one of the PSSCH DMRS, the PSCCH, the PSCCH DMRS, or the PT-RS. Then, the terminal device sequentially maps, in the sequence of first frequency domain and then time domain, the modulation symbols of the second-stage SCI to REs in the at least one allocated virtual resource block containing the PSCCH from the first OFDM symbol not containing the PSSCH DMRS but containing the PSCCH in accordance with the ascending order of indexes, and the REs to which the modulation symbols of the second-stage SCI are mapped are not occupied by at least one of the PSSCH DMRS, the PSCCH, the PSCCH DMRS, or the PT-RS.

In some embodiments, the terminal device sequentially maps, in the sequence of first frequency domain and then time domain, the modulation symbols of the second-stage SCI to REs in the at least one allocated virtual resource block starting from the first OFDM symbol in accordance with the ascending order of indexes. The OFDM symbols to which the modulation symbols of the second-stage SCI are mapped include the PSCCH and/or the PSSCH DMRS, and the REs to which the modulation symbols of the second-stage SCI are mapped are not occupied by at least one of the PSSCH DMRS, the PSCCH, the PSCCH DMRS, or the PT-RS.

In some embodiments, the terminal device sequentially maps, in the sequence of first frequency domain and then time domain, the modulation symbols of the second-stage SCI to REs of the OFDM symbols containing the PSCCH in the at least one allocated virtual resource block starting from the first OFDM symbol containing the PSCCH in accordance with the ascending order of indexes, and the REs to which the modulation symbols of the second-stage SCI are mapped are not occupied by at least one of the PSSCH DMRS, the PSCCH, the PSCCH DMRS, or the PT-RS. Then, the terminal device sequentially maps, in the sequence of first frequency domain and then time domain, the modulation symbols of the second-stage SCI to REs in the at least one allocated virtual resource block containing the PSSCH DMRS from the first OFDM symbol not containing the PSCCH but containing the PSSCH DMRS in accordance with the ascending order of indexes, and the REs to which the modulation symbols of the second-stage SCI are mapped are not occupied by at least one of the PSSCH DMRS, the PSCCH, the PSCCH DMRS, or the PT-RS.

In some embodiments, the terminal device further maps the virtual resource block to the physical resource block in a non-interleaving mode. That is, the virtual resource block n is mapped to the physical resource block n. n represents an index of the virtual resource block or the physical resource block, and n is an integer greater than or equal to 0.

The method for mapping the second-stage SCI is different from the method for mapping the second-stage SCI in the current standards where the transmitter UE indicates the method for mapping the second-stage SCI of the receiver UE by setting a second-to-last LSB in the reserved bit of SCI format 1-A as 1.

In the above method, the modulation symbols of the second-stage SCI used to indicate transmission of the SL PRS are at least mapped to all OFDM symbols containing the PSCCH DMRS and all OFDM symbols containing the PSSCH DMRS, such that the second-stage SCI is effectively received in a case where the SL PRS and the second-stage SCI are transmitted in the shared resource pool, and the effect on resource selection of the receiver terminal device is reduced.

Fifth, the modulation symbols of the second-stage SCI are only mapped to OFDM symbols containing a PSSCH DMRS.

No matter whether the PSSCH DMRS or the PSCCH DMRS is determined as the reference signal for measuring the SL RSRP in the resource pool in the resource monitoring process, the terminal device transmits the PSSCH DMRSs.

In some embodiments, the terminal device transmits all PSSCH DMRSs in the selected PSSCH DMRS pattern, such that the accuracy of channel estimation is improved.

In some embodiments, in a case where the PSCCH DMRS is determined as the reference signal for measuring the SL RSRP in the resource pool in the resource monitoring process, the terminal device transmits part of PSSCH DMRSs in the selected PSSCH DMRS pattern, such that time-frequency resources occupied by the PSSCH DMRSs are reduced.

Illustratively, in a case where the PSSCH DMRS patterns selected by the terminal device include PSSCH DMRS patterns of three OFDM symbols, the terminal device transmits PSSCH

In some embodiments, the terminal device first maps the second-stage SCI, and then maps the SL PRS.

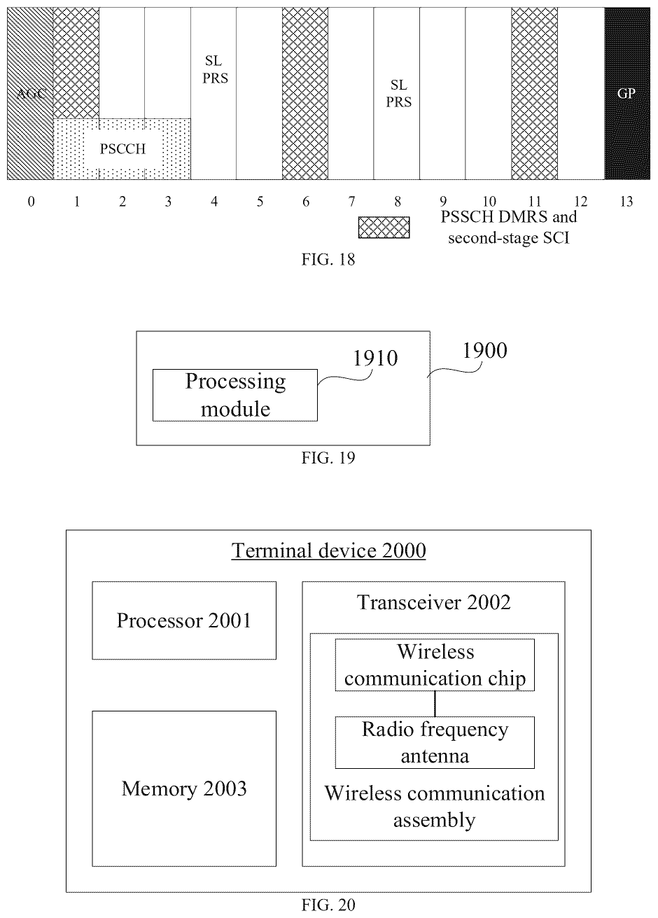

The terminal device sequentially maps, in the sequence of first frequency domain and then time domain, the modulation symbols of the second-stage SCI to REs of the OFDM symbols containing the PSSCH DMRS in the at least one allocated virtual resource block starting from the first OFDM symbol containing the PSSCH DMRS in accordance with the ascending order of indexes, and the REs to which the modulation symbols of the second-stage SCI are mapped are not occupied by at least one of the PSSCH DMRS, the PSCCH, the PSCCH DMRS, or the PT-RS. The rate matching mechanism of the second-stage SCI ensures that the modulation symbols of the second-stage SCI occupy all REs available for mapping of the second-stage SCI in any OFDM symbol on the any mapping OFDM symbol. As illustrated in FIG. 18, the terminal device maps the second-stage SCI to the first OFDM symbol, the sixth OFDM symbol, and the eleventh OFDM symbol, and the rate matching mechanism of the second-stage SCI ensures that the modulation symbols of the second-stage SCI occupy all REs available for mapping of the second-stage SCI in the first OFDM symbol, the sixth OFDM symbol, and the eleventh OFDM symbol.

In some embodiments, in a case where the modulation symbols of the second-stage SCI determined based on the rate matching mechanism of the second-stage SCI do not completely occupy all REs available for mapping of the second-stage SCI in OFDM symbols that need to be occupied, the modulation symbols of the second-stage SCI are repeatedly mapped to non-occupied REs available for mapping of the second-stage SCI in the OFDM symbols that need to be occupied. That is, in a case where the modulation symbols of the second-stage SCI do not completely occupy all REs available for the second-stage SCI in OFDM symbols containing the PSSCH DMRS, the terminal device repeatedly maps the second-stage SCI to remaining REs until all REs available for the second-stage SCI in the OFDM symbols containing the PSSCH DMRS are completely occupied.

The method for mapping the second-stage SCI is different from the method for mapping the second-stage SCI in the current standards where the transmitter UE indicates the method for mapping the second-stage SCI of the receiver UE by setting a second-to-last LSB in the reserved bit of SCI format 1-A as 1.

In the above method, the modulation symbols of the second-stage SCI used to indicate transmission of the SL PRS are mapped to the OFDM symbols containing the PSSCH DMRS, such that the second-stage SCI is effectively received in a case where the SL PRS and the second-stage SCI are transmitted in the shared resource pool, and the effect on resource selection of the receiver terminal device is reduced.

Sixth, a modulation mode of the modulation symbols of the second-stage SCI is determined based on a comb size of the SL PRS.

In the embodiments, the terminal device first maps the SL PRS, and then maps the second-stage SCI, and the modulation mode of the modulation symbols of the second-stage SCI by the terminal device is correlated with the comb size of the SL PRS.

In some embodiments, in a case where the comb size of the SL PRS is greater than 2, the modulation symbols of the second-stage SCI are mapped to REs on OFDM symbols containing the SL PRS, occupying RE offsets different from those used by the SL PRS. Illustratively, the terminal device sequentially maps, in the sequence of first frequency domain and then time domain, the modulation symbols of the second-stage SCI to REs corresponding to RE offset n1 in the OFDM symbols containing the SL PRS in the at least one allocated virtual resource block starting from the first OFDM symbol containing the SL PRS in accordance with the ascending order of indexes, and the REs to which the modulation symbols of the second-stage SCI are mapped are not occupied by at least one of the PSSCH DMRS, the PSCCH, the PSCCH DMRS, the SL PRS, or the PT-RS.

In some embodiments, in a case where any modulation symbol of the second-stage SCI is remained after the processes are performed, the terminal device sequentially maps, in the sequence of first frequency domain and then time domain, the modulation symbols of the second-stage SCI to REs corresponding to RE offset n2 in the OFDM symbols containing the SL PRS in the at least one allocated virtual resource block starting from the first OFDM symbol containing the SL PRS in accordance with the ascending order of indexes, and the REs to which the modulation symbols of the second-stage SCI are mapped are not occupied by at least one of the PSSCH DMRS, the PSCCH, the PSCCH DMRS, the SL PRS, or the PT-RS, and so on until all the modulation symbols of the second-stage SCI are mapped to the virtual resource block.

In some embodiments, the terminal device determines values of n1, n2, . . . , nk based on a value of m, and n1, n2, . . . , nk are not equal to m. m is an RE offset of the SL PRS in the OFDM symbol.

Illustratively, n1 is determined by:

$$n 1 = mod ( m + \frac{N}{2} , N ) .$$

Illustratively, n2 is determined by:

$$nn 2 = mod ( m + \frac{N}{4} , N ) .$$

N represents the comb size of the SL PRS, m represents an RE offset of the SL PRS, and n1 and n2 represent RE offsets of the modulation symbol of the second-stage SCI.

In some embodiments, in a case where the comb size of the SL PRS is equal to 2, the modulation symbols of the second-stage SCI are mapped to REs not occupied by the SL PRS and the PSSCH DMRS. Illustratively, the terminal device sequentially maps, in the sequence of first frequency domain and then time domain, the modulation symbols of the second-stage SCI to REs in the at least one allocated virtual resource block starting from the first OFDM symbol containing the SL PRS in accordance with the ascending order of indexes, and the REs to which the modulation symbols of the second-stage SCI are mapped are not occupied by at least one of the PSSCH DMRS, the PSCCH, the PSCCH DMRS, the SL PRS, or the PT-RS.

In some embodiments, in a case where the comb size of the SL PRS is equal to 1, the modulation symbols of the second-stage SCI are mapped to OFDM symbols containing the PSSCH DMRS.

In some embodiments, in a case where the comb size of the SL PRS is equal to 1, the SL PRS is mapped starting from the first OFDM symbol containing the PSSCH DMRS in the sequence from the frequency domain to the time domain, and the second-stage SCI punches the SL PRS on the OFDM symbols containing the SL PRS.

The punching of the second-stage SCI means that the modulation symbols of the second-stage SCI are mapped to the OFDM symbols containing the SL PRS, and REs for mapping the modulation symbols of the second-stage SCI are not occupied by the SL PRS.

The method for mapping the second-stage SCI is different from the method for mapping the second-stage SCI in the current standards where the transmitter UE indicates the method for mapping the second-stage SCI of the receiver UE by setting a second-to-last LSB in the reserved bit of SCI format 1-A as 1.

In the above method, the modulation mode of the modulation symbols of the second-stage SCI used to indicate the SL PRS is determined based on a comb size of the SL PRS, such that the second-stage SCI is effectively received in a case where the SL PRS and the second-stage SCI are transmitted in the shared resource pool, and the effect on resource selection of the receiver terminal device is reduced.

The following are apparatus embodiments of the present disclosure used to perform method embodiments of the present disclosure. For details not described in the apparatus embodiments of the present disclosure, reference may be made to the method embodiments of the present disclosure.

FIG. 19 is a block diagram of an apparatus for resource mapping according to some embodiments of the present disclosure. The apparatus has the function of performing the method for resource mapping. The function is implemented by hardware or by performing the corresponding software through hardware. The apparatus is the terminal device, or is disposed in the terminal device. As illustrated in FIG. 19, the apparatus 1900 includes a processing module 1910.

The processing module 1910 is configured to map modulation symbols of second-stage SCI to a time-frequency resource, wherein the second-stage SCI at least indicates transmission of an SL PRS.

In some embodiments, the modulation symbols of the second-stage SCI are mapped starting from a first OFDM symbol containing a PSSCH DMRS.

In some embodiments, the modulation symbols of the second-stage SCI are sequentially mapped, in a sequence of first frequency domain and then time domain, to REs of at least one allocated virtual resource block starting from the first OFDM symbol containing the PSSCH DMRS in accordance with an ascending order of indexes.

In some embodiments, the modulation symbols of the second-stage SCI are at least mapped to all OFDM symbols containing a PSCCH.

In some embodiments, the modulation symbols of the second-stage SCI are sequentially mapped, in a sequence of first frequency domain and then time domain, to REs of at least one allocated virtual resource block starting from a first OFDM symbol containing the PSCCH in accordance with an ascending order of indexes.

In some embodiments, the terminal device expects that a resource pool is configured with at least one PSSCH DMRS pattern with a PSSCH DMRS present on a first OFDM symbol, and the terminal device selects the PSSCH DMRS pattern with a PSSCH DMRS present on the first OFDM symbol; or
in a case where a first OFDM symbol does not contain a PSSCH DMRS, the modulation symbols of the second-stage SCI are at least mapped to an OFDM symbol containing a PSSCH DMRS pattern.

In some embodiments, the modulation symbols of the second-stage SCI are at least mapped to all OFDM symbols containing a PSSCH DMRS.

In some embodiments, the modulation symbols of the second-stage SCI are sequentially mapped, in a sequence of first frequency domain and then time domain, to REs of the OFDM symbols containing the PSSCH DMRS in at least one allocated virtual resource block starting from a first OFDM symbol containing the PSSCH DMRS in accordance with an ascending order of indexes.

In some embodiments, in a case where a number of the modulation symbols of the second-stage SCI is greater than a number of REs available for mapping of the second-stage SCI in the OFDM symbols containing the PSSCH DMRS, remaining modulation symbols of the second-stage SCI are sequentially mapped, in a sequence of first frequency domain and then time domain, to REs of the at least one allocated virtual resource block starting from a first OFDM symbol not containing the PSSCH DMRS in accordance with an ascending order of indexes.

In some embodiments, the modulation symbols of the second-stage SCI are at least mapped to all OFDM symbols containing a PSCCH and all OFDM symbols containing a PSSCH DMRS.

In some embodiments, the modulation symbols of the second-stage SCI are sequentially mapped, in a sequence of first frequency domain and then time domain, to REs of the OFDM symbols containing the PSSCH DMRS in at least one allocated virtual resource block starting from a first OFDM symbol containing the PSSCH DMRS in accordance with an ascending order of indexes, and then are sequentially mapped, in the sequence of first frequency domain and then time domain to REs of the at least one allocated virtual resource block starting from a first OFDM symbol not containing the PSSCH DMRS but containing the PSCCH in accordance with the ascending order of indexes;
the modulation symbols of the second-stage SCI are sequentially mapped, in a sequence of first frequency domain and then time domain, to REs of at least one allocated virtual resource block starting from a first OFDM symbol containing the PSCCH in accordance with an ascending order of indexes, and then are mapped, in the sequence of first frequency domain and then time domain to REs of the OFDM symbols containing the PSSCH DMRS in the at least one allocated virtual resource block starting from a first OFDM symbol not containing the PSCCH but containing the PSSCH DMRS in accordance with the ascending order of indexes; or
the modulation symbols of the second-stage SCI are sequentially mapped, in a sequence of first frequency domain and then time domain, to REs of the OFDM symbols containing the PSSCH DMRS in at least one allocated virtual resource block starting from a first OFDM symbol containing the PSSCH DMRS and/or the PSCCH in accordance with an ascending order of indexes.

In some embodiments, the modulation symbols of the second-stage SCI are only mapped to OFDM symbols containing a PSSCH DMRS.

In some embodiments, the modulation symbols of the second-stage SCI are sequentially mapped, in a sequence of first frequency domain and then time domain, to REs of the OFDM symbols containing the PSSCH DMRS in at least one allocated virtual resource block starting from a first OFDM symbol containing the PSSCH DMRS in accordance with an ascending order of indexes.

In some embodiments, a modulation mode of the modulation symbols of the second-stage SCI is determined based on a comb size of the SL PRS.

In some embodiments, in a case where the comb size of the SL PRS is greater than 2, the modulation symbols of the second-stage SCI are mapped to REs not occupied by the SL PRS on OFDM symbols containing the SL PRS;
in a case where the comb size of the SL PRS is equal to 2, the modulation symbols of the second-stage SCI are mapped to REs not occupied by the SL PRS and a PSSCH DMRS; or
in a case where the comb size of the SL PRS is equal to 1, the modulation symbols of the second-stage SCI are mapped to OFDM symbols containing a PSSCH DMRS.

In some embodiments, the modulation symbols of the second-stage SCI are mapped to REs not occupied by at least one of a PSSCH DMRS, the SL PRS, a PSCCH, a PSCCH DMRS, or a PT-RS; or
the modulation symbols of the second-stage SCI are mapped to REs not occupied by a PSSCH DMRS, a PSCCH, a PSCCH DMRS, and a PT-RS on OFDM symbols not containing the SL PRS.

In some embodiments, the SL PRS is mapped to REs not occupied by a PSSCH, a PSCCH DMRS, the second-stage SCI, and a PT-RS on OFDM symbols not containing a PSSCH DMRS;
the SL PRS is mapped to OFDM symbols not containing at least one of a PSSCH DMRS, a PSCCH, or the second-stage SCI; or
the SL PRS is mapped to REs not occupied by at least one of a PSSCH DMRS, the second-stage SCI, a PSCCH, a PSCCH DMRS, or a PT-RS.

In some embodiments, a rate matching mechanism of the second-stage SCI ensures that the modulation symbols of the second-stage SCI occupy all REs available for mapping of the second-stage SCI in a first OFDM symbol on the first mapping OFDM symbol.

In some embodiments, a rate matching mechanism of the second-stage SCI ensures that the modulation symbols of the second-stage SCI occupy all REs available for mapping of the second-stage SCI in any OFDM symbol on the any mapping OFDM symbol.

In some embodiments, in a case where the modulation symbols of the second-stage SCI determined based on a rate matching mechanism of the second-stage SCI do not completely occupy all REs available for mapping of the second-stage SCI in OFDM symbols that need to be occupied, the modulation symbols of the second-stage SCI are repeatedly mapped to non-occupied REs available for mapping of the second-stage SCI in the OFDM symbols that need to be occupied.

In some embodiments, in a case where a PSSCH DMRS or a PSCCH DMRS is determined as a reference signal for measuring an SL RSRP in a resource pool in a resource monitoring process, the terminal device transmits the PSSCH DMRS.

In some embodiments, the terminal device transmits all PSSCH DMRSs in a selected PSSCH DMRS pattern; or
in a case where a PSSCH DMRS is determined as a reference signal for measuring an SL RSRP in a resource pool in a resource monitoring process, the terminal device transmits part of PSSCH DMRSs in a selected PSSCH DMRS pattern.

In the technical solutions according to the embodiments of the present disclosure, the second-stage SCI used to indicate the transmission of SL PRS are mapped to the time-frequency resource. In a case where the SL PRS and the second-stage SCI are transmitted in the shared resource pool, the second-stage SCI is effectively received, and the effect on resource selection of the receiver terminal device is reduced.

It should be noted that, in a case where the apparatus according to the above embodiments implements the functions thereof, the division of the functional modules is merely exemplary. In practice, the above functions may be assigned to and completed by different functional modules according to actual needs, that is, the apparatus may be divided into different functional modules, to implement all or part of the above functions.

With regard to the apparatus in the above embodiments, the specific manner in which each module performs operations has been described in detail in the embodiments related to the method and is not described in detail herein. For details that are not specified in the apparatus embodiments, reference may be made to the above method embodiments.

Referring to FIG. 20, a schematic structural diagram of a terminal device according to some embodiments of the present disclosure is illustrated. The terminal device 2000 includes: a processor 2001, a transceiver 2002, and a memory 2003.

The processor 2001 includes one or more processing cores, and the processor 2001 runs various functional applications and performs information processing by running software programs and modules.

The transceiver 2002 includes a receiver and a transmitter, which are practiced, for example, as the same wireless communication assembly that includes a wireless communication chip and a radio frequency antenna.

The memory 2003 is connected to the processor 2001 and the transceiver 2002.

The memory 2003 is configured to store one or more computer programs run by the processor, and the processor 2001 is configured to run the one or more computer programs to perform the processes in the above method embodiments.

In some embodiments, the processor is configured to map modulation symbols of second-stage SCI to a time-frequency resource, wherein the second-stage SCI at least indicates transmission of an SL PRS.

For details not specified in the embodiments, reference is made to the foregoing embodiments, which are not repeated herein.

In addition, the memory may be implemented by any type or combination of volatile or non-volatile storage devices, including, but not limited to: a magnetic or optical disc, an electrically erasable programmable read-only memory (EEPROM), an erasable programmable read-only memory (EPROM), a static random-access memory (RAM), a read-only memory (ROM), a magnetic memory, a flash memory, and a programmable read-only memory (PROM).

The embodiments of the present disclosure further provide a computer-readable storage medium storing one or more computer programs therein. The one or more computer programs, when loaded and run by a processor, cause the processor to perform the method for resource reselection described above. In some embodiments, the computer-readable storage medium includes: a ROM, a RAM, a solid state drive (SSD), an optical disk, and the like. The RAM includes a resistance random-access memory (ReRAM) and a dynamic random access memory (DRAM).

Some embodiments of the present disclosure further provide a chip including programmable logic circuitry and/or one or more program instructions. The chip, when running, is configured to perform the method for resource mapping in above embodiments.

Some embodiments of the present disclosure further provide a computer program product. The computer program product includes one or more computer instructions stored in a computer-readable storage medium. The one or more computer instructions, when read from the computer-readable storage medium and executed by a processor, cause the processor to perform the method for resource mapping in above embodiments

It should be understood that the term “indication” mentioned in the embodiments of the present disclosure is a direct indication, an indirect indication, or an indication that there is an association relationship. For example, A indicates B, which may mean that A indicates B directly, e.g., B may be acquired by A; or that A indicates B indirectly, e.g., A indicates C by which B may be acquired; or that an association relationship is present between A and B.

In the description of the embodiments of the present disclosure, the term “correspond” indicates a direct or indirect corresponding relationship between two items, or indicates an associated relationship between the two items; and also indicates relationships such as indicating and being indicated, or configuring and being configured.

In some embodiments of the present disclosure, the term “predefined” is implemented by pre-storing corresponding codes, tables, or other means that may be defined to indicate related information in devices (including, for example, terminal devices and network devices), and the present disclosure does not limit the specific implementation thereof. For example, “predefined” refers to “defined” in a protocol.

In some embodiments of the present disclosure, the “protocol” refers to a standard protocol in the communication field including, for example, the LTE protocol, the NR protocol, and related protocols applied in future communication systems, which is not limited in the present disclosure.

The mentioned term “a plurality of” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

Reference herein to “greater than or equal to” may indicate greater than or equal to or just greater than, and “less than or equal to” may indicate less than or equal to or just less than.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in a reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for resource mapping, performed by a terminal device, the method comprising:
mapping modulation symbols of second-stage sidelink control information (SCI) to a time-frequency resource, wherein the second-stage SCI at least indicates transmission of a sidelink (SL) positioning reference signal (PRS).

2. The method according to claim 1, wherein the modulation symbols of the second-stage SCI are mapped starting from a first orthogonal frequency-division multiplexing (OFDM) symbol containing a physical sidelink shared channel (PSSCH) demodulation reference signal (DMRS).

3. The method according to claim 2, wherein the modulation symbols of the second-stage SCI are sequentially mapped, in a sequence of first frequency domain and then time domain, to resource elements (REs) of at least one allocated virtual resource block starting from the first OFDM symbol containing the PSSCH DMRS in accordance with an ascending order of indexes.

4. The method according to claim 1, wherein:
the modulation symbols of the second-stage SCI are mapped to resource elements (REs) not occupied by at least one of a physical sidelink shared channel (PSSCH) demodulation reference signal (DMRS), the SL PRS, a physical sidelink control channel (PSCCH), a PSCCH DMRS, or a phase track reference signal (PT-RS); or
the modulation symbols of the second-stage SCI are mapped to REs not occupied by a PSSCH DMRS, a PSCCH, a PSCCH DMRS, and a PT-RS on orthogonal frequency-division multiplexing (OFDM) symbols not containing the SL PRS.

5. The method according to claim 1, wherein:
the SL PRS is mapped to resource elements (REs) not occupied by a physical sidelink shared channel (PSSCH), a PSCCH demodulation reference signal (DMRS), the second-stage SCI, and a phase track reference signal (PT-RS) on orthogonal frequency-division multiplexing (OFDM) symbols not containing a physical sidelink shared channel (PSSCH) DMRS;
the SL PRS is mapped to OFDM symbols not containing at least one of a PSSCH DMRS, a PSCCH, or the second-stage SCI; or
the SL PRS is mapped to REs not occupied by at least one of a PSSCH DMRS, the second-stage SCI, a PSCCH, a PSCCH DMRS, or a PT-RS.

6. The method according to claim 1, wherein in a case where a physical sidelink shared channel (PSSCH) demodulation reference signal (DMRS) or a physical sidelink control channel (PSCCH) DMRS is determined as a reference signal for measuring an SL reference signal receive power (RSRP) in a resource pool in a resource monitoring process, the terminal device transmits the PSSCH DMRS.

7. The method according to claim 1, wherein:
the terminal device transmits all physical sidelink shared channel (PSSCH) demodulation reference signals (DMRSs) in a selected PSSCH DMRS pattern; or
in a case where a PSSCH DMRS is determined as a reference signal for measuring an SL reference signal receive power (RSRP) in a resource pool in a resource monitoring process, the terminal device transmits part of PSSCH DMRSs in a selected PSSCH DMRS pattern.

8. A terminal device, comprising:
a processor and a memory storing one or more computer programs;
wherein the processor is configured to execute the one or more computer programs to cause the terminal device to:
map modulation symbols of second-stage sidelink control information (SCI) to a time-frequency resource, wherein the second-stage SCI at least indicates transmission of a sidelink (SL) positioning reference signal (PRS).

9. The terminal device according to claim 8, wherein the modulation symbols of the second-stage SCI are mapped starting from a first orthogonal frequency-division multiplexing (OFDM) symbol containing a physical sidelink shared channel (PSSCH) demodulation reference signal (DMRS).

10. The terminal device according to claim 9, wherein the modulation symbols of the second-stage SCI are sequentially mapped, in a sequence of first frequency domain and then time domain, to resource elements (REs) of at least one allocated virtual resource block starting from the first OFDM symbol containing the PSSCH DMRS in accordance with an ascending order of indexes.

11. The terminal device according to claim 8, wherein:
the modulation symbols of the second-stage SCI are mapped to resource elements (REs) not occupied by at least one of a physical sidelink shared channel (PSSCH) demodulation reference signal (DMRS), the SL PRS, a physical sidelink control channel (PSCCH), a PSCCH DMRS, or a phase track reference signal (PT-RS); or
the modulation symbols of the second-stage SCI are mapped to REs not occupied by a PSSCH DMRS, a PSCCH, a PSCCH DMRS, and a PT-RS on orthogonal frequency-division multiplexing (OFDM) symbols not containing the SL PRS.

12. The terminal device according to claim 8, wherein:
the SL PRS is mapped to resource elements (REs) not occupied by a physical sidelink shared channel (PSSCH), a PSCCH demodulation reference signal (DMRS), the second-stage SCI, and a phase track reference signal (PT-RS) on orthogonal frequency-division multiplexing (OFDM) symbols not containing a physical sidelink shared channel (PSSCH) DMRS;
the SL PRS is mapped to OFDM symbols not containing at least one of a PSSCH DMRS, a PSCCH, or the second-stage SCI; or
the SL PRS is mapped to REs not occupied by at least one of a PSSCH DMRS, the second-stage SCI, a PSCCH, a PSCCH DMRS, or a PT-RS.

13. The terminal device according to claim 8, wherein in a case where a physical sidelink shared channel (PSSCH) demodulation reference signal (DMRS) or a physical sidelink control channel (PSCCH) DMRS is determined as a reference signal for measuring an SL reference signal receive power (RSRP) in a resource pool in a resource monitoring process, the terminal device transmits the PSSCH DMRS.

14. The terminal device according to claim 8, wherein:
the terminal device transmits all physical sidelink shared channel (PSSCH) demodulation reference signals (DMRSs) in a selected PSSCH DMRS pattern; or
in a case where a PSSCH DMRS is determined as a reference signal for measuring an SL reference signal receive power (RSRP) in a resource pool in a resource monitoring process, the terminal device transmits part of PSSCH DMRSs in a selected PSSCH DMRS pattern.

15. A chip, comprising:
programmable logic circuitry and/or program instructions, configured to cause the chip to:
map modulation symbols of second-stage sidelink control information (SCI) to a time-frequency resource, wherein the second-stage SCI at least indicates transmission of a sidelink (SL) positioning reference signal (PRS).

16. The chip according to claim 15, wherein the modulation symbols of the second-stage SCI are mapped starting from a first orthogonal frequency-division multiplexing (OFDM) symbol containing a physical sidelink shared channel (PSSCH) demodulation reference signal (DMRS).

17. The chip according to claim 16, wherein the modulation symbols of the second-stage SCI are sequentially mapped, in a sequence of first frequency domain and then time domain, to resource elements (REs) of at least one allocated virtual resource block starting from the first OFDM symbol containing the PSSCH DMRS in accordance with an ascending order of indexes.

18. The chip according to claim 15, wherein:
the modulation symbols of the second-stage SCI are mapped to resource elements (REs) not occupied by at least one of a physical sidelink shared channel (PSSCH) demodulation reference signal (DMRS), the SL PRS, a physical sidelink control channel (PSCCH), a PSCCH DMRS, or a phase track reference signal (PT-RS); or
the modulation symbols of the second-stage SCI are mapped to REs not occupied by a PSSCH DMRS, a PSCCH, a PSCCH DMRS, and a PT-RS on orthogonal frequency-division multiplexing (OFDM) symbols not containing the SL PRS.

19. The chip according to claim 15, wherein:
the SL PRS is mapped to resource elements (REs) not occupied by a physical sidelink shared channel (PSSCH), a PSCCH demodulation reference signal (DMRS), the second-stage SCI, and a phase track reference signal (PT-RS) on orthogonal frequency-division multiplexing (OFDM) symbols not containing a physical sidelink shared channel (PSSCH) DMRS;
the SL PRS is mapped to OFDM symbols not containing at least one of a PSSCH DMRS, a PSCCH, or the second-stage SCI; or
the SL PRS is mapped to REs not occupied by at least one of a PSSCH DMRS, the second-stage SCI, a PSCCH, a PSCCH DMRS, or a PT-RS.

20. The chip according to claim 15, wherein in a case where a physical sidelink shared channel (PSSCH) demodulation reference signal (DMRS) or a physical sidelink control channel (PSCCH) DMRS is determined as a reference signal for measuring an SL reference signal receive power (RSRP) in a resource pool in a resource monitoring process, the chip transmits the PSSCH DMRS.
